(19) United States
(12) Patent Application Publication
(10) Pub. No.: US 2010/0310857 A1
(43) Pub. Date: Dec. 9, 2010

(54) Inorganic-polymer composite material, adhesive layer, and adhesive film

(75) Inventors: Tomonari Naito, Osaka (JP); Mika Okada, Osaka (JP); Asami Kubo, Osaka (JP)

Correspondence Address: AKERMAN SENTERFITT, 8100 BOONE BOULEVARD, SUITE 700, VIENNA, VA, 22182-2683, US

(73) Assignee: Nitto Denko Corporation, Osaka (JP)

(21) Appl. No.: 12/735,578

(22) PCT Filed: Feb. 5, 2009
(86) PCT No.: PCT/JP2009/000450

§ 371 Date: Jul. 29, 2010

(30) Foreign Application Priority Data
Feb. 7, 2008 (JP) 2008-028237
Jan. 28, 2009 (JP) 2009-017276

(51) Int. Cl. B32B 27/04

(52) U.S. Cl. 428/327; 428/407

(57) ABSTRACT

An inorganic-polymer composite material includes a hydrophilic inorganic compound that has a maximum length of 1 to 1000 nm and is unevenly distributed on the surface of a polymer particle having an average particle size of 0.05 to 100 μm.

### TECHNICAL FIELD

The present invention relates to an inorganic-polymer composite material; and an adhesive layer and an adhesive film in which the inorganic-polymer composite material is used.

### BACKGROUND ART

In these days, it has been known that a clay mineral is added to an aqueous-dispersion type resin to achieve an improvement in various characteristics.

For example, it has been proposed that a polymer latex is obtained by blending a montmorillonite clay in water to obtain slurry therefrom; then dissolving dodecyl trimethyl ammonium bromide as a swelling agent (hydrophobizing treatment agent) in the slurry to prepare a clay slurry; thereafter, adding a monomer solution containing isoprene and styrene to the clay slurry, and stirring (emulsifying) and heating (polymerizing) the mixture (for example, see Patent Document 1 below).
Patent Document 1: Japanese Unexamined Patent Application No. 2001-518122

### DISCLOSURE OF THE INVENTION

### Problem to be Solved by the Invention

However, in the polymer latex proposed in Patent Document 1 mentioned above, by blending dodecyl trimethyl ammonium bromide, the montmorillonite clay is hydrophobized and mutually coagulated in the clay slurry. Therefore, when the monomer solution is added to such a clay slurry, the monomer solution penetrates into the coagulated montmorillonite clay.

Then, there is a problem in that when the monomer solution in the clay slurry is polymerized, rather than the montmorillonite clay being supported on the surface of the polymer, the montmorillonite clay enters inside of the polymer, which adversely decreases mechanical properties.

An object of the present invention is to provide an inorganic-polymer composite material that is capable of achieving improvement in various characteristics while maintaining mechanical properties of polymer particles; and an adhesive layer and an adhesive film in which the inorganic-polymer composite material is used.

### Means for Solving the Problem

To achieve the above-described object, an inorganic-polymer composite material of the present invention includes a hydrophilic inorganic compound that has a maximum length of 1 to 1000 nm and is unevenly distributed on the surface of a polymer particle having an average particle size of 0.05 to 100 μm.

It is preferable that in the inorganic-polymer composite material of the present invention, the content proportion of the hydrophilic inorganic compound relative to 100 parts by weight of the polymer particle is 4 to 200 parts by weight.

It is preferable that the inorganic-polymer composite material of the present invention encapsulates a hydrophobic inorganic compound having a maximum length of 1 to 200 nm.

It is preferable that in the inorganic-polymer composite material of the present invention, the content proportion of the hydrophobic inorganic compound relative to 100 parts by weight of the polymer particle is 0.1 to 15 parts by weight.

It is preferable that the hydrophobic inorganic compound of the present invention is a hydrophobic inorganic compound having a bulk-form, needle-form, or plate-form.

It is preferable that in the inorganic-polymer composite material of the present invention, the polymer particle is an aqueous-dispersion type polymer particle.

It is preferable that in the inorganic-polymer composite material of the present invention, the hydrophilic inorganic compound is a hydrophilic layered clay mineral, and/or a hydrophilic inorganic compound having a bulk-form, needle-form, or plate-form.

An adhesive layer of the present invention includes an inorganic-polymer composite material, wherein the inorganic-polymer composite material includes a hydrophilic inorganic compound that has a maximum length of 1 to 1000 nm and is unevenly distributed on the surface of a polymer particle having an average particle size of 0.05 to 100 μm.

An adhesive film of the present invention includes an adhesive layer on at least one side of a support, wherein the adhesive layer contains an inorganic-polymer composite material, the inorganic-polymer composite material including a hydrophilic inorganic compound that has a maximum length of 1 to 1000 nm and is unevenly distributed on the surface of a polymer particle having an average particle size of 0.05 to 100 μm.

### EFFECT OF THE INVENTION

In the inorganic-polymer composite material of the present invention, a hydrophilic inorganic compound is unevenly distributed on the surface of a polymer particle. Therefore, a heat-releasing characteristic material, a conductive material, and further adhesiveness are excellent, while mechanical properties of the polymer particles are maintained.

Thus, the adhesive layer and the adhesive film in which the inorganic-polymer composite material of the present invention is used are capable of developing excellent adhesiveness.

### BRIEF DESCRIPTION OF THE DRAWINGS

FIG. 1 is a cross-sectional view of an example of an adhesive film in which an inorganic-polymer composite material of the present invention is used.

FIG. 2 illustrates a processed TEM image of an inorganic-polymer composite material of Example 1.

FIG. 3 illustrates a processed TEM image of an inorganic-polymer composite material of Example 2.

FIG. 4 illustrates a processed TEM image of an inorganic-polymer composite material of Example 4.

FIG. 5 illustrates a processed TEM image of an inorganic-polymer composite material of Example 8.

FIG. 6 illustrates a processed TEM image of an inorganic-polymer composite material of Example 9.

FIG. 7 illustrates a processed TEM image of an inorganic-polymer composite material of Example 10.

FIG. 8 illustrates a processed SEM image of an inorganic-polymer composite material of Example 13.

FIG. 9 illustrates a processed SEM image of an inorganic-polymer composite material of Example 14.

FIG. 10 illustrates a processed SEM image of an inorganic-polymer composite material of Example 15.

FIG. 11 illustrates a processed SEM image of an inorganic-polymer composite material of Example 16.

FIG. 12 illustrates a processed SEM image of an inorganic-polymer composite material of Example 17.

FIG. 13 illustrates a processed SEM image of an inorganic-polymer composite material of Example 18.

FIG. 14 illustrates a processed TEM image of an inorganic-polymer composite material of Example 19.

FIG. 15 illustrates a processed SEM image of an inorganic-polymer composite material of Example 20.

FIG. 16 illustrates a processed TEM image of an inorganic-polymer composite material of Example 20.

FIG. 17 illustrates a processed SEM image of an inorganic-polymer composite material of Example 21.

FIG. 18 illustrates a processed SEM image of an inorganic-polymer composite material of Example 22.

FIG. 19 illustrates a processed SEM image of an inorganic-polymer composite material of Example 23.

FIG. 20 illustrates a processed SEM image of an inorganic-polymer composite material of Example 24.

FIG. 21 illustrates a processed SEM image of an inorganic-polymer composite material of Example 25.

FIG. 22 illustrates a processed SEM image of an inorganic-polymer composite material of Example 26.

FIG. 23 illustrates a processed SEM image of an inorganic-polymer composite material of Example 27.

FIG. 24 illustrates a processed SEM image of an inorganic-polymer composite material of Example 28.

FIG. 25 illustrates a processed SEM image of an inorganic-polymer composite material of Example 29.

FIG. 26 illustrates a processed SEM image of an inorganic-polymer composite material of Example 30.

FIG. 27 illustrates a processed TEM image of an inorganic-polymer composite material of Example 31.

FIG. 28 illustrates a processed TEM image of an inorganic-polymer composite material of Example 32.

FIG. 29 illustrates a processed TEM image of an inorganic-polymer composite material of Comparative Example 3.

FIG. 30 illustrates a processed TEM image of an inorganic-polymer composite material of Comparative Example 4.

FIG. 31 illustrates a processed TEM image of an inorganic-polymer composite material of Comparative Example 5.

FIG. 32 illustrates a processed TEM image of an inorganic-polymer composite material of Comparative Example 6.

FIG. 33 illustrates a processed TEM image of an inorganic-polymer composite material of Comparative Example 7.

FIG. 34 illustrates a processed TEM image of a polymer of Comparative Example 8.

FIG. 35 illustrates a processed TEM image of an inorganic-polymer composite material of Comparative Example 9.

FIG. 36 illustrates a processed TEM image of an inorganic-polymer composite material of Comparative Example 10.

FIG. 37 illustrates a processed TEM image of an inorganic-polymer composite material of Comparative Example 11.

### EMBODIMENT OF THE INVENTION

In the inorganic-polymer composite material of the present invention, a hydrophilic inorganic compound is unevenly distributed on the surface of polymer particles. That is, the hydrophilic inorganic compound is supported in a dispersed state on the surface of the polymer particles. Such an inorganic-polymer composite material of the present invention can be obtained as a polymer latex by a production method described below.

That is, the inorganic-polymer composite material of the present invention can be obtained, as a polymer latex, by a production method including the steps of: dispersing a hydrophilic inorganic compound in water to prepare an aqueous dispersion of the hydrophilic inorganic compound (aqueous dispersion preparation step); blending the aqueous dispersion and an ethylenically unsaturated monomer and emulsifying the ethylenically unsaturated monomer to prepare a monomer emulsion (monomer emulsion preparation step); blending a surfactant with at least one of water, the aqueous dispersion, the ethylenically unsaturated monomer, and the monomer emulsion (surfactant blending step); and polymerizing the ethylenically unsaturated monomer in the monomer emulsion (polymerization step).

Examples of the hydrophilic inorganic compound include a hydrophilic layered clay mineral and/or a hydrophilic inorganic compound having a specific form (excluding the layered form).

Examples of the hydrophilic layered clay mineral include phylosilicate minerals in which 2-dimentionally extending layers are plurally laminated, for example, smectite.

Examples of smectite include montmorillonite group minerals, such as, for example, montmorillonite, magnesian montmorillonite, ferri-montmorillonite, ferro-magnesian montmorillonite, beidellite, aluminian beidellite, nontronite, aluminian nontronite, saponite, aluminian saponite, hectorite, sauconite, stevensite, and bentonite.

Examples of the hydrophilic layered clay mineral also include vermiculite, halloysite, swelling mica, and graphite.

These hydrophilic layered clay minerals may be used singly, or may be used in combination of two or more.

Commercially available general products may be used for these hydrophilic layered clay minerals, and examples thereof include, to be more specific, as natural products, Kunipia series (montmorillonite, manufactured by KUNIMINE INDUSTRIES CO., LTD.), Ben-Gel series (bentonite, manufactured by HOJUN Co., Ltd.), and Somasif ME series (swelling mica, manufactured by Co-op Chemical Co., Ltd.); and as synthesized products, Sumecton (saponite, manufactured by KUNIMINE INDUSTRIES CO., LTD.), Lucentite SWN series (hectorite, manufactured by Co-op Chemical Co., Ltd.), and LAPONITE (hectorite, manufactured by Lockwood Holdings, Inc.). Preferably, in view of the fact that small oil drops can be obtained because synthesized products generally have a short maximum length compared with natural products, synthesized products are used.

As to the size of the hydrophilic layered clay mineral, the thickness of each layer thereof is, for example, 0.5 to 2 nm, to be specific, about 1 nm; and the length (maximum length) of each layer thereof is, for example, 1 to 1000 nm, preferably, 20 to 800 nm, or more preferably 30 to 700 nm. When the size of the hydrophilic layered clay mineral exceeds the above range, oil drops having a target particle size may not be obtained.

The hydrophilic inorganic compound having a specific form is hydrophilic, and is in a bulk-form, a needle-form, or a plate-form (excluding the layered form).

Examples of the bulk-form hydrophilic inorganic compound include a hydrophilic inorganic compound having a spherical form, a rectangular parallelepiped form, or an irregular form thereof. Examples of the bulk-form hydrophilic inorganic compound include hydrophilic silica, calcium carbonate, titanium oxide, tin oxide (including antimony-doped tin oxide), alumina, magnesium hydroxide, barium titanate, zinc oxide, silicon nitride, silicon carbide, carbon (diamond), and metal microparticles.

Examples of the needle-form hydrophilic inorganic compound include potassium titanate, wollastonite, sepiolite, needle tin oxide, needle magnesium hydroxide, and alumina.

The plate-form hydrophilic inorganic compound is a plate-form hydrophilic inorganic compound excluding layer-form inorganic compound (hydrophilic inorganic compound) such as hydrophilic layered clay mineral, and examples thereof include boron nitride, plate calcium carbonate, and plate aluminum hydroxide.

These hydrophilic inorganic compounds may be used singly, or may be used in combination of two or more. Preferably, antimony-doped tin oxide, titanium oxide, tin oxide, alumina, zinc oxide, boron nitride, silicon nitride, silicon carbide, and carbon (diamond) are used.

Commercially available general products may be used for these hydrophilic inorganic compounds having a specific form, and examples thereof include, to be more specific, as antimony-doped tin oxide, SN-100S, SN-100P, SN-100D manufactured by ISHIHARA SANGYO KAISHA, LTD. (aqueously dispersed product); as titanium oxide, ITO series manufactured by ISHIHARA SANGYO KAISHA, LTD.; as zinc oxide, SnO-310, SnO-350, SnO-410 manufactured by SUMITOMO OSAKA CEMENT Co., Ltd.; as alumina, NANOBYK series manufactured by BYK Japan KK, or Alumina Sol series manufactured by NISSAN CHEMICAL INDUSTRIES, LTD.; as silicon carbide, SiC series manufactured by SUMITOMO OSAKA CEMENT Co., Ltd.; and as diamond, diamond powder series.

The size of the hydrophilic inorganic compound having a specific form is, in the case of the bulk-form (spherical) hydrophilic inorganic compound, in terms of the average primary particle size, for example, 1 to 400 nm, preferably 1 to 200 nm, or more preferably 5 to 100 nm. When the size of the hydrophilic inorganic compound having a specific form exceeds the above range, oil drops having a target particle size may not be obtained.

In the case of the needle-form hydrophilic inorganic compound or the plate-form hydrophilic inorganic compound, the maximum length thereof is, for example, 1 to 400 nm, preferably 1 to 200 nm, or more preferably 5 to 200 nm. When the maximum length of the needle-form hydrophilic inorganic compound or the plate-form hydrophilic inorganic compound exceeds the above range, oil drops having a target particle size may not be obtained. The aspect ratio of the needle-form hydrophilic inorganic compound or the plate-form hydrophilic inorganic compound (in the case of needle-form, expressed by major axis length/minor axis length, or by major axis length/thickness, and in the case of plate-form, expressed by diagonal length/thickness, or by long side length/thickness) is, for example, 5 to 200, or preferably 10 to 100.

It is necessary that the hydrophilic inorganic compound having a specific form is present at an interface between water and oil drops of the ethylenically unsaturated monomer in the monomer emulsion preparation step, and that the hydrophilic inorganic compound having a specific form is supported so as to be unevenly distributed on the surface of the polymer particle after the polymerization step.

Thus, when the hydrophilic inorganic compound is hydrophobic, the hydrophilic inorganic compound stably exists in the oil phase in the monomer emulsion preparation step and cannot be present at an interface between water and oil drops, and as a result, cannot be emulsified. On the other hand, when the hydrophilic inorganic compound is excessively hydrophilic, the hydrophilic inorganic compound stably exists in water, and in this case as well cannot be present at an interface between water and oil drops of the ethylenically unsaturated monomer, and as a result, may not be emulsified.

Therefore, when the hydrophilic inorganic compound is excessively hydrophilic, and cannot be emulsified, as necessary, the surface of the hydrophilic inorganic compound is partially treated with a surface treatment agent.

Examples of the surface treatment agent include general surface modifying agents such as a coupling agent and fatty acid. Examples of the coupling agent include a silane-based coupling agent, a titanium-based coupling agent, and an aluminum-based coupling agent.

Examples of the silane-based silane coupling agent include 3-methacryloxypropyl-trimethoxysilane, 3-acryloxypropyl-trimethoxysilane, 3-methacryloxypropyl-triethoxysilane, 3-acryloxypropyl-triethoxysilane, 3-methacryloxypropylmethyl-dimethoxysilane, 3-acryloxypropylmethyl-dimethoxysilane, 3-methacryloxypropylmethyl-diethoxysilane, 3-acryloxypropylmethyl-diethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloxydecyltrimethoxysilane, 10-acryloxydecyltrimethoxysilane, 10-methacryloxydecyltriethoxysilane, 10-acryloxydecyltriethoxysilane, methyltrimethoxysilane, butyltrimethoxysilane, hexyltrimethoxysilane, decyltrimethoxysilane, hexadecyltrimethoxysilane, octadecyldimethylmethoxysilane, tetramethoxysilane, tetraethoxysilane, dimethoxydimethylsilane, methoxytrimethylsilane, diethoxydimethylsilane, methyltrimethoxysilane, methyltriethoxysilane, phenyltrimethoxysilane, phenyltriethoxysilane, dimethoxydiphenylsilane, diphenylethoxymethylsilane, dimethoxymethylphenylsilane, and hexamethylenedisilazane.

Examples of the titanium-based coupling agent include isopropyltriisostearoyltitanate, isopropyltridodecylbenzenesulfonyltitanate, isopropyltris(dioctylpyrophosphate)titanate, tetraisopropylbis(dioctylphosphite)titanate, tetraoctylbis(ditridecylphosphite)titanate, tetra(2,2-diallyloxymethyl-1-butyl)bis(ditridecyl)phosphitetitanate, bis(dioctylpyrophosphate)oxyacetatetitanate, bis(dioctylpyrophosphate)ethylene titanate, isopropyltri(dioctylphosphate)titanate, isopropyltricumylphenyl titanate, and isopropyltri(N-amideethyl•aminoethyl)titanate.

An example of the aluminum-based coupling agent is acetalkoxyaluminumdiisopropylate.

Examples of fatty acid include stearic acid, oleic acid, linoleic acid, linolenic acid, and eleostearic acid.

Examples of such surface treatment with a surface treatment agent include a dry method in which an aqueous alcohol solution, organic solvent solution (organic solvent excluding alcohol. For example, acetone etc.) or aqueous solution of the surface treatment agent is added to the hydrophilic inorganic compound having a specific form while stirring in a mixer; a wet method in which a surface treatment agent is added after the hydrophilic inorganic compound having a specific form is dispersed in an aqueous alcohol solution or aqueous solution; and a spray method in which a surface treatment agent is sprayed on the hydrophilic inorganic compound having a specific form.

In the case of the hydrophilic inorganic compound having a specific form that is excessively hydrophilic, a commercially available product that is surface treated in advance may be used.

An example of the ethylenically unsaturated monomer is (meth)acrylic acid alkyl ester. (Meth)acrylic acid alkyl ester is, for example, (meth)acrylic acid alkyl ester (methacrylic acid alkyl ester, and/or acrylic acid alkyl ester) having an alkyl group with 1 to 18 carbon atoms, and examples thereof include (meth)acrylic acid alkyl (linear or branched alkyl having 1 to 18 carbon atoms) ester such as methyl(meth)acrylate, ethyl(meth)acrylate, propyl(meth)acrylate, isopropylbutyl(meth)acrylate, butyl(meth)acrylate, isobutyl(meth)acrylate, sec-butyl(meth)acrylate, t-butyl(meth)acrylate, pentyl(meth)acrylate, neopentyl(meth)acrylate, isoamyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate(lauryl(meth)acrylate), tridecyl(meth)acrylate, tetradecyl(meth)acrylate, pentadecyl(meth)acrylate, hexadecyl(meth)acrylate, heptadecyl(meth)acrylate, 2-methylheptadecyl(meth)acrylate(isostearyl(meth)acrylate), octadecyl(meth)acrylate, and 2-ethylhexadecyl(meth)acrylate.

Among these (meth)acrylic acid alkyl esters, preferably, butyl acrylate, methyl methacrylate, lauryl methacrylate, 2-ethylhexyl acrylate, isostearyl acrylate, and 2-ethylhexadecyl(meth)acrylate are used. These (meth)acrylic acid alkyl esters may be used singly, or may be used in combination of two or more.

Examples of the ethylenically unsaturated monomer include a copolymerizable polymer that is copolymerizable with (meth)acrylic acid alkyl ester.

Examples of the copolymerizable vinyl monomer include aromatic vinyl monomers such as styrene and vinyl toluene; (meth)acrylic acid alicyclic hydrocarbon esters such as cyclopentyl di(meth)acrylate, cyclohexyl(meth)acrylate, bornyl(meth)acrylate, and isobornyl(meth)acrylate; (meth)acrylic acid aryl ester such as phenyl(meth)acrylate; an alkoxy group-containing unsaturated monomer such as methoxyethyl(meth)acrylate and ethoxyethyl(meth)acrylate; olefinic monomers such as ethylene, propylene, isoprene, butadiene, and isobutylene; a vinylether monomer such as vinylether; a halogen atom-containing unsaturated monomer such as vinyl chloride; as well as vinyl group-containing heterocyclic compounds such as N-vinylpyrrolidone, N-(1-methylvinyl)pyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, and tetrahydrofurfuryl(meth)acrylate; and an acrylic acid ester-based monomer containing a halogen atom such as a fluorine atom, such as fluorine(meth)acrylate.

Examples of the copolymerizable vinyl monomer also include functional group-containing vinyl monomers such as carboxyl group-containing monomers such as acrylic acid, methacrylic acid, fumaric acid, maleic acid, crotonic acid, and carboxyethyl(meth)acrylate; carboxylic acid vinyl ester such as vinyl acetate and vinyl propionate; hydroxyl group-containing vinyl monomers such as 2-hydroxyethyl acrylate, 2-hydroxypropyl acrylate, and 2-hydroxybutyl acrylate; amide group-containing unsaturated monomers such as (meth)acrylamide, N,N-dimethyl(meth)acrylamide, N,N-diethyl(meth)acrylamide, N-isopropyl(meth)acrylamide, N-butyl(meth)acrylamide, N-methoxymethyl(meth)acrylamide, N-methylol(meth)acryl amide, N-methylolpropane(meth)acrylamide, and N-vinylcarboxylic acid amide; amino-group-containing unsaturated monomers such as aminoethyl(meth)acrylate, N,N-dimethylaminoethyl(meth)acrylate, and t-butylaminoethyl(meth)acrylate; glycidyl group-containing unsaturated monomers such as glycidyl(meth)acrylate and methyl glycidyl(meth)acrylate; cyano group-containing unsaturated monomers such as acrylonitrile and methacrylonitrile; an isocyanate group-containing unsaturated monomer such as 2-methacryloyloxyethylisocyanate; sulfonic acid group-containing unsaturated monomers such as styrenesulfonate, allylsulfonate, 2-(meth)acrylamide-2-methylpropanesulfonate, (meth)acrylamidepropanesulfonate, sulfopropyl(meth)acrylate, and (meth)acryloyloxynaphthalenesulfonate; maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; glycol acrylester monomers such as polyethylene glycol(meth)acrylate, polypropylene glycol(meth)acrylate, methoxyethylene glycol(meth)acrylate, and methoxypolypropyleneglycol(meth)acrylate.

An example of the above-described functional group-containing vinyl monomer includes polyfunctional monomers.

Examples of the polyfunctional monomer include (mono or poly) alkyleneglycol di(meth)acrylate such as (mono or poly) ethylene glycol di(meth)acrylate including, for example, ethylene glycol di(meth)acrylate, diethylene glycol di(meth)acrylate, triethylene glycol di(meth)acrylate, trimethylolpropanetri(meth)acrylate, and tetraethylene glycol di(meth)acrylate, and (mono or poly) propylene glycol di(meth)acrylate such as propylene glycol di(meth)acrylate; a (meth)acrylic acid ester monomer of polyhydric alcohols such as neopentyl glycol di(meth)acrylate, 1,6-hexandiol di(meth)acrylate, pentaerythritol di(meth)acrylate, trimethylolpropanetri(meth)acrylate, pentaerythritoltri(meth)acrylate, and dipentaerythritolhexa(meth)acrylate, and also include divinylbenzene. Examples of the polyfunctional monomer also include epoxyacrylate, polyesteracrylate, and urethaneacrylate.

An example of the copolymerizable vinyl monomer includes an alkoxysilyl group-containing vinyl monomer. Examples of the alkoxysilyl group-containing vinyl monomer include silicone(meth)acrylate monomers and silicone vinyl monomers.

Examples of the silicone(meth)acryl ate monomer include (meth)acryloyloxyalkyl-trialkoxysilane such as (meth)acryloyloxymethyl-trimethoxysilane, (meth)acryloyloxymethyl-triethoxysilane, 2-(meth)acryloyloxyethyl-trimethoxysilane, 2-(meth)acryloyloxyethyl-triethoxysilane, 3-(meth)acryloyloxypropyl-trimethoxysilane, 3-(meth)acryloyloxypropyl-triethoxysilane, 3-(meth)acryloyloxypropyl-tripropoxysilane, 3-(meth)acryloyloxypropyl-triisopropoxysilane, and 3-(meth)acryloyloxypropyl-tributoxysilane; (meth)acryloyloxyalkyl-alkyldialkoxysilane such as (meth)acryloyloxymethyl-methyldimethoxysilane, (meth)acryloyloxymethyl-methyldiethoxysilane, 2-(meth)acryloyloxyethyl-methyldimethoxysilane, 2-(meth)acryloyloxyethyl-methyldiethoxysilane, 3-(meth)acryloyloxypropyl-methyldimethoxysilane, 3-(meth)acryloyloxypropyl-methyldiethoxysilane, 3-(meth)acryloyloxypropyl-methyldipropoxysilane, 3-(meth)acryloyloxypropyl-methyldiisopropoxysilane, 3-(meth)acryloyloxypropyl-methyldibutoxysilane, 3-(meth)acryloyloxypropyl-ethyldimethoxysilane, 3-(meth)acryloyloxypropyl-ethyldiethoxysilane, 3-(meth)acryloyloxypropyl-ethyldipropoxysilane, 3-(meth)acryloyloxypropyl-ethyldiisopropoxysilane, 3-(meth)acryloyloxypropyl-ethyldibutoxysilane, 3-(meth)acryloyloxypropyl-propyldimethoxysilane, 3-(meth)acryloyloxypropyl-propyldiethoxysilane; and (meth)acryloyloxyalkyl-dialkyl(mono)alkoxysilane corresponding thereto.

Examples of the silicone vinyl monomer include vinyltrialkoxysilane such as vinyltrimethoxysilane, vinyltriethoxysilane, vinyltripropoxysilane, vinyltriisopropoxysilane, and vinyltributoxysilane as well as vinylalkyldialkoxysilane and vinyldialkylalkoxysilane corresponding thereto; vinylalkyltrialkoxysilane such as vinylmethyltrimethoxysilane, vinylmethyltriethoxysilane, β-vinylethyltrimethoxysilane, β-vinylethyltriethoxysilane, γ-vinylpropyltrimethoxysilane, γ-vinylpropyltriethoxysilane, γ-vinylpropyltripropoxysilane, γ-vinylpropyltriisopropoxysilane, γ-vinylpropyltributoxysilane as well as (vinylalkyl)alkyldialkoxysilane and (vinylalkyl)dialkyl(mono)alkoxysilane corresponding thereto.

These copolymerizable vinyl monomers may be used singly, or may be used in combination of two or more.

Among these copolymerizable vinyl monomers, preferably, an alkoxysilyl group-containing vinyl monomer is used.

By using an alkoxysilyl group-containing vinyl monomer as the copolymerizable vinyl monomer, the alkoxysilyl group is introduced into the polymer chain, and reaction between the alkoxysilyl groups allows formation of a crosslinked structure.

Such a copolymerizable vinyl monomer may be optionally used along with (meth)acrylic acid alkyl ester as necessary, or may be used singly.

When the copolymerizable vinyl monomer is used along with (meth)acrylic acid alkyl ester, the mixing ratio of the copolymerizable vinyl monomer is, for example, 40 parts by weight or less, preferably 30 parts by weight or less, or more preferably 20 parts by weight or less relative to 100 parts by weight of the ethylenically unsaturated monomer. When the copolymerizable vinyl monomer is an alkoxysilyl group-containing vinyl monomer, the mixing ratio of the alkoxysilyl group-containing vinyl monomer is, for example, 0.001 to 10 parts by weight, or preferably 0.01 to 5 parts by weight relative to 100 parts by weight of (meth)acrylic acid alkyl ester.

Examples of the surfactant include known surfactants (surfactant mentioned in “Surfactant Physical Property and Performance Handbook, Noboru Moriyama, Technical Information Institute Publishing”), such as a dispersing agent that mainly acts on an interface between liquid and solid, and an emulsifying agent that mainly acts on an interface between liquids.

Examples of the dispersing agent include phosphoric acid-based dispersing agents and carboxylic acid-based dispersing agents. Examples of the phosphoric acid-based dispersing agent include sodium orthophosphate, sodium pyrophosphate, sodium tripolyphosphate, sodium tetraphosphate, sodium hexametaphosphate, and trisodium phosphate. Examples of the carboxylic acid-based dispersing agent include a polymer dispersing agent based on polyacrylic acid, polymethacrylic acid, an acrylic acid/maleic acid copolymer, a styrene/maleic acid copolymer, etc.

Commercially available general products may be used as the polymer dispersing agent, including, for example, AQUALIC series (polyacrylic acid-based or acrylic acid/maleic acid copolymer-based, manufactured by NIPPON SHOKUBAI CO., LTD.), Aron series (polyacrylic acid-based, manufactured by TOAGOSEI CO., LTD.), Shallol series (polyacrylic acid-based, manufactured by DAI-ICHI KOGYO SEIYAKU CO., LTD.), POIZ series (acrylic acid/maleic acid copolymer-based, manufactured by Kao Corporation), SN Dispersant series (polycarboxylic acid copolymer-based, manufactured by SAN NOPCO LIMITED), and EFKA series (polyacrylic acid-based, manufactured by Ciba Inc.).

Examples of the emulsifying agent include anionic emulsifying agents such as sodium lauryl sulfate, ammonium lauryl sulfate, sodium dodecylbenzenesulfonate, sodium polyoxyethylene lauryl sulfate, sodium polyoxyethylenealkylether sulfate, ammonium polyoxyethylenealkylphenylether sulfate, sodium polyoxyethylenealkylphenylether sulfate, and sodium polyoxyethylenealkylsulfo succinate; and nonionic emulsifying agents such as polyoxyethylenealkylether, polyoxyethylenealkylphenylether, polyoxyethylene fatty acid ester, and a polyoxyethylenepolyoxypropylene block polymer.

Examples of the emulsifying agent also include a radical polymerization (reaction) emulsifying agent, in which a radical polymerization functional group (reactive group) such as propenyl group and allyl ether group is introduced into such an anion-based emulsifying agent or a nonionic emulsifying agent.

These surfactants may be used singly, or may be used in combination of two or more.

In the present invention, an aqueous dispersion of the hydrophilic inorganic compound is prepared, for example, by blending the above-described hydrophilic inorganic compound and water first, and then stir-mixing them, thus dispersing the hydrophilic inorganic compound in water (aqueous dispersion preparation step).

The mixing ratio of the hydrophilic inorganic compound is, for example, 0.1 to 50 parts by weight, preferably 0.2 to 40 parts by weight, or more preferably 0.5 to 30 parts by weight relative to 100 parts by weight of water. When the hydrophilic inorganic compound is a hydrophilic layered clay mineral, the mixing ratio of the hydrophilic inorganic compound is, for example, 0.1 to 11 parts by weight, or preferably 0.5 to 5 parts by weight relative to 100 parts by weight of water.

When the mixing ratio of the hydrophilic inorganic compound exceeds the above-described range, the viscosity of the aqueous dispersion may become excessively high, and coagulation may be caused in the polymerization step.

On the other hand, when the mixing ratio of the hydrophilic inorganic compound is below the above-described range, the hydrophilic inorganic compound content proportion in the inorganic-polymer composite material becomes excessively low, which may not allow the hydrophilic inorganic compound to be supported on the surface of the polymer particles uniformly.

Upon using the hydrophilic layered clay mineral as the hydrophilic inorganic compound, when the mixing ratio of the hydrophilic layered clay mineral exceeds the above-described range, the viscosity of the aqueous dispersion becomes excessively high, and the fluidity of the aqueous dispersion decreases excessively, and therefore the hydrophilic layered clay mineral may not be swollen uniformly and sufficiently. Also, a decrease in the viscosity of the monomer emulsion may be caused in the monomer emulsion preparation step, which causes necessity to set the solid content concentration of the obtained polymer to a predetermined range in the polymerization step, making the step complicated.

On the other hand, when the mixing ratio of the hydrophilic layered clay mineral is below the above-described range, the hydrophilic layered clay mineral content proportion in the inorganic-polymer composite material becomes excessively low, which may not allow the hydrophilic layered clay mineral to be supported on the surface of the polymer particles uniformly.

For stir-mixing the water in which the hydrophilic inorganic compound is blended, for example, a known mixer such as a disper and an ultrasonic homogenizer is used.

When the hydrophilic inorganic compound is the hydrophilic layered clay mineral, the water in which the hydrophilic layered clay mineral is blended may be allowed to stand, for example, for 12 to 48 hours, or preferably 24 to 36 hours, before the above-described stir-mixing. By allowing the water in which the hydrophilic layered clay mineral is blended to stand, for example, the hydrophilic layered clay mineral is allowed to swell in water, and by the stir-mixing that follows, the hydrophilic layered clay mineral is allowed to exfoliate from each other to be reliably dispersed in water.

In such stir-mixing, the surface of the hydrophilic inorganic compound having a specific form may also be subjected to a partial surface treatment.

Thereafter, for example, the aqueous dispersion and the ethylenically unsaturated monomer are blended, and then the mixture is subjected to stir-mixing to emulsify the ethylenically unsaturated monomer, thereby preparing a monomer emulsion (monomer emulsion preparation step).

In the blending of the aqueous dispersion and the ethylenically unsaturated monomer, the mixing ratio of the hydrophilic inorganic compound is 4 to 200 parts by weight, preferably 5 to 150 parts by weight, or more preferably 8 to 100 parts by weight relative to 100 parts by weight of the ethylenically unsaturated monomer.

When the mixing ratio of the hydrophilic inorganic compound is below the above-described range, a stable emulsion form cannot be obtained in the monomer emulsion preparation step, and the rate of coverage by the hydrophilic inorganic compound on the polymer particle becomes excessively low.

On the other hand, when the mixing ratio of the hydrophilic inorganic compound exceeds the above-described range, the rate of coverage by the hydrophilic inorganic compound on the polymer particle becomes excessively high, and the viscosity increases, which may cause necessity for adjustment of the viscosity.

In the monomer emulsion preparation step, the hydrophobic inorganic compound may be dispersed in the above-described ethylenically unsaturated monomer to prepare a monomer dispersion liquid of the hydrophobic inorganic compound (monomer dispersion liquid preparation step), and then the obtained monomer dispersion liquid of the hydrophobic inorganic compound may be emulsified in advance. This allows the inorganic-polymer composite material to encapsulate the hydrophobic inorganic compound.

The form of the hydrophobic inorganic compound is not particularly limited, and preferably the form is a specific form such as a bulk-form, a needle-form, or a plate-form (excluding the layered form).

The bulk-form hydrophobic inorganic compound includes, for example, a hydrophobic inorganic compound having a spherical form, a rectangular parallelepiped form, and an irregular form thereof. Examples of the bulk-form hydrophobic inorganic compound include silica, calcium carbonate, titanium oxide, tin oxide (including antimony-doped tin oxide), alumina, magnesium hydroxide, barium titanate, zinc oxide, silicon nitride, and metal microparticles.

Examples of the needle-form hydrophobic inorganic compound include potassium titanate, wollastonite, sepiolite, needle tin oxide, and needle magnesium hydroxide.

The plate-form hydrophobic inorganic compound is a hydrophobic inorganic compound in a plate-form excluding the layer-form hydrophobic inorganic compound, and examples thereof include boron nitride, plate calcium carbonate, and plate aluminum hydroxide.

These hydrophobic inorganic compounds may be used singly, or may be used in combination of two or more.

Preferably, silica, titanium oxide, antimony-doped tin oxide, zinc oxide, boron nitride, and silicon nitride are used.

As the hydrophobic inorganic compound, the above-described hydrophilic inorganic compound having a specific form (bulk-form, needle-form, or plate-form) may be subjected to a surface treatment using the above-described surface treatment agent to be hydrophobized and used. The surface treatment method that is the same as the above-described method may be used.

As such a hydrophobic inorganic compound, commercially available general products may be used: for example, as silica, Aerosil® series (manufactured by Nippon Aerosil Co., Ltd.); and for example, as titanium oxide, TTO series (manufactured by ISHIHARA SANGYO KAISHA, LTD.).

Examples of Aerosil series include Aerosil R8200 (average primary particle size 12 nm, hexamethyldisilazane treatment), Aerosil 8104 (average primary particle size 12 nm, octamethyl cyclotetrasiloxane treatment), Aerosil R974 (average primary particle size 12 nm, dimethyldichlorosilane treatment), and Aerosil R812 (average primary particle size 7 nm, hexamethyldisilazane treatment). Examples of TTO series include TTO-51(C) (average primary particle size 10 to 30 nm, aluminum hydroxide/stearic acid treatment), TTO-55(C) (average primary particle size 30 to 50 nm, aluminum hydroxide/stearic acid treatment), and TTO-55(D) (average primary particle size 30 to 50 nm, aluminum hydroxide/zirconium oxide treatment).

The size of the hydrophobic inorganic compound is, in terms of the average primary particle size (in the case of needle-form or plate-form, the maximum length), 1 to 200 nm, preferably 5 to 150 nm, more preferably 5 to 100 nm, or most preferably 5 to 50 nm. When the average primary particle size of the hydrophobic inorganic compound is larger than the above-described range, the hydrophobic inorganic compound may not be encapsulated in oil drops of a desired particle size, and may coagulate during polymerization.

To prepare a monomer dispersion liquid, the above-described hydrophobic inorganic compound and ethylenically unsaturated monomer are blended, and subjected to stir-mixing with the above-described known mixer, thus dispersing the hydrophobic inorganic compound in the ethylenically unsaturated monomer.

The mixing ratio of the hydrophobic inorganic compound is, for example, 0.1 to 15 parts by weight, or preferably 0.5 to 10 parts by weight relative to 100 parts by weight of the ethylenically unsaturated monomer. In other words, in the inorganic-polymer composite material, the hydrophobic inorganic compound content proportion is, for example, 0.1 to 15 parts by weight, or preferably 0.5 to 10 parts by weight relative to 100 parts by weight of the polymer particles.

When the mixing ratio (content proportion) of the hydrophobic inorganic compound exceeds the above-described range, the hydrophobic inorganic compound may not be encapsulated completely in oil drops, and may coagulate during polymerization.

To emulsify the ethylenically unsaturated monomer (or monomer dispersion liquid), for example, the aqueous dispersion and an oil phase liquid containing the ethylenically unsaturated monomer are blended, and then, for example, the mixture is emulsified with an emulsifying apparatus.

The oil phase liquid contains, for example, the ethylenically unsaturated monomer as the essential component, and contains, as optional components, an initiator and a hydrophobic compound (or monomer dispersion liquid) as necessary.

Examples of the initiator include a polymerization initiator usually used in emulsion polymerization. For example, an oil-soluble initiator or a water-soluble initiator is used.

Examples of the oil-soluble initiator include oil-soluble peroxide-based initiators such as benzoylperoxide, lauroylperoxide; and oil-soluble azo-based initiators such as dimethyl 2,2′-azobis(2-methylpropionate) (as a commercially available product, for example, V-601, manufactured by Wako Pure Chemical Industries, Ltd.), 2,2′-azobis(4-methoxy-2,4-dimethylvaleronitrile), 2,2′-azobis(2,4-dimethyldimethylvaleronitrile), 2,2′-azobis(2-methyl-butyronitrile), 1,1′-azobis(cyclohexane-1-carbonitrile), and 2,2′-azobisisobutyronitrile (AIBN), and azobis(2-methylbutyronitrile).

Examples of the water-soluble initiator include azo-based initiators (excluding oil-soluble azo-based initiator) such as 2,2′-azobis(2-methylpropionamidine)disulfate, 2,2′-azobis(2-methylpropionamidine)dihydrochloride, 2,2′-azobis(2-amidinopropane)dihydrochloride, 2,2′-azobis[N-(2-carboxyethyl)-2-methylpropionamidine]hydrate, 2,2′-azobis(N,N′-dimethyleneisobutylamidine), and 2,2′-azobis[2-(2-imidazoline-2-yl)propane]dihydrochloride; persulfate-based initiators such as potassium persulfate and ammonium persulfate; peroxide-based initiators (excluding oil-soluble peroxide-based initiator) such as t-butylhydroperoxide and hydrogen peroxide; a substituted ethane-based initiator such as phenylsubstituted ethane; a carbonyl-based initiator such as an aromatic carbonyl compound; and a redox-based initiator such as a combination of persulfate and sodium hydrogen sulfite, and a combination of peroxide and sodium ascorbic acid.

These initiators are appropriately used singly or in combination. Among the initiators, preferably, an oil-soluble initiator, or more preferably an oil-soluble azo-based initiator is used.

Although the mixing ratio of the initiator is appropriately selected, for example, the mixing ratio of the initiator is 0.005 to 1 part by weight relative to 100 parts by weight of the ethylenically unsaturated monomer.

The hydrophobic compound is a hydrophobic organic compound excluding the above-described hydrophobic inorganic compound, and examples thereof include higher alkanes having 8 to 30 carbon atoms such as dodecane, hexadecane, and octadecane; higher alcohols having an alkyl group with 8 to 30 carbon atoms such as laurylalcohol, cetylalcohol, and stearylalcohol; alkyl(meth)acrylates having an alkyl group with 8 to 30 carbon atoms such as lauryl(meth)acrylate and stearyl(meth)acrylate; thiols having an alkyl group with 8 to 30 carbon atoms such as laurylmercaptan, cetylmercaptan, and stearylmercaptan; and polymers such as polystyrene, and polymethyl(meth)acrylate. These hydrophobic compounds may be used alone, or may be used in combination of two or more. Preferably, the higher alkanes are used. When the alkyl(meth)acrylates having an alkyl group with 8 to 30 carbon atoms is used as the ethylenically unsaturated monomer, because the alkyl(meth)acrylates may function as the hydrophobic compound, and therefore the hydrophobic compound may not have to be blended.

The mixing ratio of the hydrophobic compound is, for example, 1 to 80 parts by weight, or preferably 1 to 60 parts by weight relative to 100 parts by weight of the ethylenically unsaturated monomer.

When the hydrophobic compound is blended in the oil phase liquid, the oil drops in the monomer emulsion can be maintained to a median diameter of a specific range.

To include an optional component in the oil phase liquid, the initiator and the hydrophobic compound are added to and dissolved in the ethylenically unsaturated monomer.

Although the optional component is blended in the oil phase liquid in the description above, for example, the optional component may also be added directly in the monomer emulsion.

Examples of the emulsifying apparatus include an ultrasonic homogenizer, a high-pressure homogenizer (PANDA 2K, manufactured by GEA NIRO-SOAVI S.p.A.), Microfluidizer® (manufactured by Microfluidics), Nanomizer® (Yoshida Kikai co., ltd.), TK HOMO MIXER (manufactured by PRIMIX Corporation), and TK Filmix (manufactured by PRIMIX Corporation).

In the ultrasonic homogenizer, the frequency of the ultrasonic waves used is not particularly limited, for example, 20 to 40 kHz. In the ultrasonic homogenizer, due to the cavitation effects by ultrasonic irradiation, oil drops of the ethylenically unsaturated monomer are micronized to the above-described median diameter.

In the high-pressure homogenizer, microfluidizer, and nanomizer, the pressure to be applied is not particularly limited. For example, the pressure is 10 to 300 MPa. In the high-pressure homogenizer, microfluidizer, and nanomizer, the dispersion liquid is discharged from micropores while applying a pressure, and due to application of a high shearing force generated at such discharging, oil drops are micronized to the above-described median diameter.

TK HOMO MIXER and TK Filmix are emulsifying apparatuses that use the high-speed rotation of a rotator, and by the high-speed rotation of the rotator in the mixture liquid, a high shearing force is added to the mixture liquid, and oil drops are micronized to the above-described median diameter.

These emulsifying apparatuses may be used singly, or may be used in combination of two or more in multi-levels.

In this way, the volume-based median diameter of oil drops of the emulsified ethylenically unsaturated monomer is, for example, 100 μm or less, preferably 40 μm or less, or more preferably 4 μm or less, and usually 0.05 μm or more.

When the hydrophilic inorganic compound is the hydrophilic layered clay mineral, the volume-based median diameter of oil drops of the emulsified ethylenically unsaturated monomer is preferably 4 μm or less, more preferably 1 μm or less, still more preferably 0.5 μm or less, and usually 0.05 μm or more.

When the median diameter of oil drops exceeds the above-described range, coagulation may occur in the polymerization step.

The volume-based median diameter of oil drops of the monomer emulsion is measured with a laser diffraction particle size analyzer. As the laser diffraction particle size analyzer, usually, a commercially available general product is used. To be specific, LS13 320 (manufactured by Beckman Coulter, Inc.) and the like are used with the measurement conditions of the following: laser light source, laser diode and tungsten lamp; and a wavelength of 450 to 900 nm.

Then, for example, by heating the monomer emulsion, ethylenically unsaturated monomer in the monomer emulsion is polymerized.

Heating temperature (polymerization temperature) is set, for example, to 40 to 90° C., and polymerization time is set, for example, to 1 to 10 hours.

The monomer emulsion can be polymerized at once with the above-described reaction conditions; the monomer emulsion can be partially polymerized and then the remaining monomer emulsion can be, for example, subjected to drop polymerization afterwards; or a reaction vessel is charged with water in advance and after raising the temperature to the above-described temperature, the monomer emulsion is added dropwise or added dividedly.

In the present invention, the surfactant is blended in at least one of water, the aqueous dispersion, the ethylenically unsaturated monomer, and the monomer emulsion. The mixing ratio of the surfactant is, for example, 0.01 to 20 parts by weight, or preferably 0.05 to 15 parts by weight relative to 100 parts by weight of the hydrophilic inorganic compound.

When the surfactant is to be blended in water, the surfactant is added, to the water before the hydrophilic inorganic compound is blended in, or the water to which the hydrophilic inorganic compound is blended but before subjected to dispersion in the aqueous dispersion preparation step. Preferably, the dispersing agent is blended therein. By blending the surfactant in water, primary particles of the hydrophilic inorganic compound that coagulate can be dispersed. When the hydrophilic inorganic compound is the hydrophilic layered clay mineral, dispersiveness of the hydrophilic layered clay mineral in the aqueous dispersion can be improved, the viscosity of the aqueous dispersion can be decreased, and the solid content concentration of the emulsion to be obtained can be easily adjusted to a predetermined range.

When the surfactant is to be blended in the aqueous dispersion, the surfactant is added to the prepared aqueous dispersion in the monomer emulsion preparation step (after the aqueous dispersion preparation step). Preferably, the dispersing agent is added. By blending in the surfactant in the aqueous dispersion, dispersiveness of the hydrophilic inorganic compound in the aqueous dispersion is improved, viscosity of the aqueous dispersion is decreased, and the solid content concentration of the emulsion to be obtained can be easily adjusted to a predetermined range.

When the surfactant is to be blended in the oil phase liquid, the surfactant is added to the prepared oil phase liquid (to be specific, the ethylenically unsaturated monomer) in the monomer emulsion preparation step. Preferably, the emulsifying agent is blended. By blending the surfactant in the oil phase liquid, a monomer emulsion of stable emulsion form can be obtained.

When the surfactant is to be blended in the monomer emulsion, the surfactant is added to the prepared monomer emulsion in the polymerization step. Preferably, the emulsifying agent is blended. By blending the surfactant in the monomer emulsion, high polymerization stability can be obtained.

When the monomer emulsion is to be prepared from the monomer dispersion liquid, the surfactant is blended in at least one of water, the aqueous dispersion, the ethylenically unsaturated monomer, the monomer dispersion liquid, and the monomer emulsion.

By adding the surfactant to the monomer dispersion liquid, a monomer emulsion of stable emulsion form can be obtained.

By such polymerization, an emulsion of the inorganic-polymer composite material, in which the hydrophilic inorganic compound is supported on the surface of the polymer particles (that is, aqueous-dispersion type polymer particles), can be obtained.

The solid content concentration of the emulsion is, for example, 5 to 50 wt %, preferably 6 to 45 wt %, or more preferably 8 to 40 wt %. When the solid content concentration of the emulsion exceeds the above-described range, the viscosity of the emulsion in the polymerization step becomes excessively high, which may lead to a decrease in handleability, and control of polymerization temperature may become difficult. When the solid content concentration of the emulsion is below the above-described range, productivity may decrease.

The volume-based median diameter of the inorganic-polymer composite material in the emulsion is, for example, 100 μm or less, preferably 40 μm or less, or more preferably 4 μm or less, and usually 0.05 μm or more; and when the hydrophilic inorganic compound is the hydrophilic layered clay mineral, 4 μm or less, preferably 1 μm or less, or more preferably 0.5 μm or less, and usually 0.05 μm or more, i.e., about the same as the volume-based median diameter of oil drops.

Furthermore, as necessary, additives such as, for example, a pH adjuster (aqueous acetic acid solution, etc.), a cross-linking agent (isocyanate-based, epoxy-based, oxazoline-based, aziridine-based, and metal chelate-based), a chain transfer agent (thiols), a viscosity adjuster, a peeling adjuster, a plasticizer, a softener, a filler, a coloring agent (pigment, dye, etc.), an age resister, and a surfactant may be added in an appropriate amount to the inorganic-polymer composite material. These additives may be added after the polymerization step, or may be added to the liquids in the aqueous dispersion preparation step, the monomer emulsion preparation step, and the polymerization step.

In the present invention, the aqueous dispersion is prepared without adding a hydrophobizing treatment agent such as a swelling agent (to be specific, dodecyl trimethyl ammonium bromide, etc.) to the aqueous dispersion. When the hydrophobizing treatment agent is added, hydrophilicity of the hydrophilic inorganic compound is decreased, dispersiveness in the aqueous dispersion is decreased, and the hydrophilic inorganic compound is not supported on the surface of the polymer particle uniformly.

Thus obtained inorganic-polymer composite material is composed, as described above, such that the hydrophilic inorganic compound having a maximum length of 1 to 1000 nm is unevenly distributed on the surface of the polymer particles having an average particle size of 0.05 to 100 μm. That is, in the inorganic-polymer composite material, the polymer particles support the hydrophilic inorganic compound at the outer surface of the polymer particles without encapsulating the hydrophilic inorganic compound.

As a result, in the inorganic-polymer composite material of the present invention, continuous path of the hydrophilic inorganic compound can be formed with the polymer particles serving as a matrix, and therefore the inorganic-polymer composite material of the present invention can be suitably used in various industrial fields, as a heat-releasing material or a conductive material.

Furthermore, because of excellent adhesiveness, the inorganic-polymer composite material of the present invention can be suitably used also as an adhesive layer or an adhesive film.

In particular, when the monomer dispersion liquid of the hydrophobic inorganic compound is used, the obtained inorganic-polymer composite material (polymer particles) encapsulates (that is, internally contains) the hydrophobic inorganic compound, not the hydrophilic inorganic compound. Meanwhile, the inorganic-polymer composite material (polymer particles) can be composed so as to support (unevenly distribute) the hydrophilic inorganic compound on the outer surface of the inorganic-polymer composite material.

That is, the hydrophilic inorganic compound and the hydrophobic inorganic compound can be composed such that the hydrophilic inorganic compound is unevenly distributed on the outer surface of the polymer particles, and the hydrophobic inorganic compound is included inside the polymer particle.

Therefore, an adhesive layer composed of the inorganic-polymer composite material in which the hydrophobic inorganic compound is present evenly inside can be obtained, and an improvement in mechanical strength of the adhesive layer can be achieved.

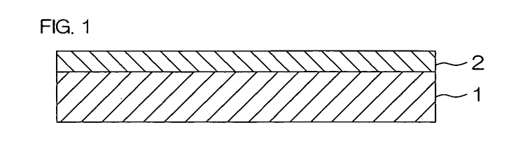

FIG. 1 is a cross-sectional view of an example of an adhesive film in which an inorganic-polymer composite material of the present invention is used.

In the following, an example of a method for producing an adhesive layer and an adhesive film using the inorganic-polymer composite material of the present invention will be described.

In this method, first, a substrate 1 as a support is prepared.

Examples of a material that forms the substrate 1 include a film made of polyolefins such as polyethylene, polypropylene, and an ethylene-propylene copolymer; a film made of polyesters such as polyethylene terephthalate; a film made of plastics such as polyvinyl chloride; papers such as kraft paper and Japanese paper; fabrics such as cotton fabrics and staple fiber fabrics; nonwoven fabrics such as polyester nonwoven fabrics and vinylon nonwoven fabrics; and metal foils.

The substrate 1 is formed into, for example, a sheet (film) or a tape.

As necessary, the substrate 1 may be subjected to a known treatment such as, for example, an undercoating treatment, a filling treatment, a corona treatment, and a back face treatment.

The thickness of the substrate 1 is appropriately selected in accordance with its use and purpose, and is, for example, 20 to 150 μm, or preferably 30 to 100 μm.

Then, an adhesive layer 2 is laminated on one side of the substrate 1.

To provide the adhesive layer 2, for example, an emulsion of the inorganic-polymer composite material is directly applied on one side of the substrate 1 by a known application method such as roll application, screen application, or gravure application, and thereafter, for example, heated at 50 to 180° C. to be dried.

The adhesive layer 2 may also be transferred to the substrate 1 from an exfoliate sheet to which the adhesive layer 2 is laminated.

The exfoliate sheet to which the adhesive layer 2 is laminated is formed, for example, by directly applying the emulsion of the inorganic-polymer composite material on a known exfoliate sheet by a known application method, and heating the applied emulsion to be dried, thereby forming the adhesive layer 2. To transfer the adhesive layer 2, the exfoliate sheet to which the adhesive layer 2 is laminated is bonded to the substrate 1 such that one side of the substrate 1 and the adhesive layer 2 are brought in contact, and then the exfoliate sheet is peeled off from the adhesive layer 2.

The thickness (thickness after drying) of thus formed adhesive layer 2 is selected appropriately in accordance with its use and purpose, and is set in the range of, for example, about 1.0 to 100 μm, or preferably about 3.0 to 50 μm.

Although the adhesive layer 2 is provided on one side of the substrate 1 in the above description with reference to FIG. 1, for example, the adhesive layer 2 may be provided on both sides of the substrate 1.

Examples of the above-described adhesive film include an adhesive sheet and an adhesive tape.

In such an adhesive film, the adhesive layer has excellent mechanical properties, to be specific, adhesiveness. The adhesive layer has high loss modulus G″, and loss tangent tans that are obtained by a dynamic viscoelasticity measurement, and therefore it is assumed that the adhesive layer has excellent damping-vibration characteristics.

Furthermore, because the adhesive layer has excellent adhesiveness, heat resistance, and moisture resistance, the adhesive film has excellent adhesiveness, heat resistance, and moisture resistance.

### Examples

In the following, the present invention will be described in more detail with reference to Examples and Comparative Examples. However, the present invention is not limited to Examples and Comparative Examples by no means.

### Example 1

### (Aqueous Dispersion Preparation Step)

10 parts by weight of Lucentite SWN (hydrophilic layered clay mineral, maximum length of each layer: 50 nm, manufactured by Co-op Chemical Co., Ltd.) was added to 464 parts by weight of water, and the mixture was allowed to stand for 24 hours. The mixture was subjected to stir-mixing for 3 minutes with an ultrasonic homogenizer, thereby obtaining an aqueous dispersion.

### (Monomer Emulsion Preparation Step)

100 parts by weight of butyl acrylate, 5 parts by weight of hexadecane, and 0.25 parts by weight of an initiator (dimethyl 2,2′-azobis(2-methylpropionate), oil-soluble azo-based initiator, trade name: V-601, manufactured by Wako Pure Chemical Industries, Ltd.) were mixed, thereby preparing an oil phase liquid.

Then, the oil phase liquid and the aqueous dispersion were mixed, and the mixture was stirred using a TK HOMO MIXER (manufactured by PRIMIX Corporation) for 1 minute at 6000 (l/min) to forcibly emulsify, thereby preparing a monomer pre-emulsion. Then, this monomer pre-emulsion was subjected to a treatment using a high-pressure homogenizer (PANDA 2K) at a pressure of 100 MPa for 2 passes, and 5 parts by weight (1 part by weight by solid content) of a 20 wt % emulsifying agent solution (anionic non-reactive emulsifying agent, trade name: HITENOL LA-16, manufactured by DAI-ICHI KOGYO SEIYAKU CO., LTD.) was added thereto, thereby obtaining a monomer emulsion.

### (Polymerization Step)

A reaction vessel equipped with a condenser tube, a nitrogen inlet tube, a thermometer, and a mixer was charged with the prepared monomer emulsion, then, after the reaction vessel atmosphere was replaced with nitrogen, the temperature was raised to 70° C., and the prepared monomer emulsion was polymerized for 3 hours, thereby obtaining an emulsion of an inorganic-polymer composite material having a solid content concentration of 20%.

### Example 2

A monomer emulsion was prepared in the same manner as in Example 1, except that 0.03 parts by weight of 3-methacryloyloxypropyl-trimethoxysilane (KBM-503, manufactured by Shin-Etsu Chemical Co., Ltd.) was further added to the oil phase liquid in the monomer emulsion preparation step; and then the monomer emulsion was polymerized, thereby obtaining an emulsion of an inorganic-polymer composite material having a solid content concentration of 20%.

### Example 3

A monomer emulsion was prepared in the same manner as in Example 1, except that 0.03 parts by weight of 3-methacryloyloxypropyl-trimethoxysilane (KBM-503, manufactured by Shin-Etsu Chemical Co., Ltd.) was further added to the oil phase liquid, and the blending parts by weight of Lucentite SWN (hydrophilic layered clay mineral, maximum length of each layer: 50 nm, manufactured by Co-op Chemical Co., Ltd.) was changed to 20 parts by weight, and the blending parts by weight of water was changed to 504 parts by weight in the monomer emulsion preparation step; and then the monomer emulsion was polymerized, thereby obtaining an emulsion of an inorganic-polymer composite material having a solid content concentration of 20%.

### Example 4

### (Aqueous Dispersion Preparation Step)

5 parts by weight of Lucentite SWN (hydrophilic layered clay mineral, maximum length of each layer: 50 nm, manufactured by Co-op Chemical Co., Ltd.) was added to 631 parts by weight of water, and allowed to stand for 24 hours. The mixture was subjected to stir-mixing for 3 minutes with an ultrasonic homogenizer, thereby obtaining an aqueous dispersion.

### (Monomer Emulsion Preparation Step)

100 parts by weight of butyl acrylate, 5 parts by weight of hexadecane, 0.03 parts by weight of 3-methacryloyloxypropyl-trimethoxysilane (KBM-503, manufactured by Shin-Etsu Chemical Co., Ltd.), and 0.25 parts by weight of an initiator (dimethyl 2,2′-azobis(2-methylpropionate), oil-soluble azo-based initiator, trade name: V-601, manufactured by Wako Pure Chemical Industries, Ltd.) were mixed, thereby preparing an oil phase liquid.

Then, the oil phase liquid and the aqueous dispersion were mixed, and the mixture was stirred using a TK HOMO MIXER (manufactured by PRIMIX Corporation) for 1 minute at 6000 (l/min) to forcibly emulsify, thereby preparing a monomer pre-emulsion. Then, this monomer pre-emulsion was subjected to a treatment using a high-pressure homogenizer (PANDA 2K) at a pressure of 100 MPa for 2 passes, and 2.5 parts by weight (0.5 parts by weight by solid content) of a 20 wt % emulsifying agent solution (anionic non-reactive emulsifying agent, trade name: HITENOL LA-16, manufactured by DAI-ICHI KOGYO SEIYAKU CO., LTD.) and 5 parts by weight (1 part by weight by solid content) of a 20% dispersing agent solution (Shallol AN-103P, polymer dispersing agent, manufactured by DAI-ICHI KOGYO SEIYAKU CO., LTD.) were added thereto, thereby obtaining a monomer emulsion.

### (Polymerization Step)

A reaction vessel equipped with a condenser tube, a nitrogen inlet tube, a thermometer, and a mixer was charged with the prepared monomer emulsion, then, after the reaction vessel atmosphere was replaced with nitrogen, the temperature was raised to 70° C., and the prepared monomer emulsion was polymerized for 3 hours, thereby obtaining an emulsion of an inorganic-polymer composite material having a solid content concentration of 15%.

### Example 5

A monomer emulsion was prepared in the same manner as in Example 1, except that 0.03 parts by weight of 3-methacryloyloxypropyl-trimethoxysilane (KBM-503, manufactured by Shin-Etsu Chemical Co., Ltd.) was further added to the oil phase liquid, the blending parts by weight of water was changed to 271 parts by weight, and instead of the 20 wt % emulsifying agent solution (anionic non-reactive emulsifying agent, trade name: HITENOL LA-16, manufactured by DAI-ICHI KOGYO SEIYAKU CO., LTD.), a 20% dispersing agent solution (Shallol AN-103P, polymer dispersing agent, manufactured by DAI-ICHI KOGYO SEIYAKU CO., LTD.) was used in the monomer emulsion preparation step; and then the monomer emulsion was polymerized, thereby obtaining an emulsion of an inorganic-polymer composite material having a solid content concentration of 30%.

### Example 6

### (Aqueous Dispersion Preparation Step)

50 parts by weight of Lucentite SWN (hydrophilic layered clay mineral, maximum length of each layer: 50 nm, manufactured by Co-op Chemical Co., Ltd.) was added to 1056 parts by weight of water, and allowed to stand for 24 hours. 12.5 parts by weight (2.5 parts by weight by solid content) of a 20% dispersing agent solution (Shallol AN-103P, polymer dispersing agent, manufactured by DAI-ICHI KOGYO SEIYAKU CO., LTD.) was added thereto, and the mixture was subjected to stir-mixing for 3 minutes with an ultrasonic homogenizer, thereby obtaining an aqueous dispersion.

### (Monomer Emulsion Preparation Step)

100 parts by weight of butyl acrylate, 5 parts by weight of hexadecane, 0.03 parts by weight of 3-methacryloyloxypropyl-trimethoxysilane (KBM-503, manufactured by Shin-Etsu Chemical Co., Ltd.), 0.25 parts by weight of an initiator (dimethyl 2,2′-azobis(2-methylpropionate), oil-soluble azo-based initiator, trade name: V-601, manufactured by Wako Pure Chemical Industries, Ltd.) were mixed, thereby preparing an oil phase liquid.

Then, the oil phase liquid and the aqueous dispersion were mixed, and the mixture was stirred using a TK HOMO MIXER (manufactured by PRIMIX Corporation) for 1 minute at 6000 (l/min) to forcibly emulsify, thereby preparing a monomer pre-emulsion. Then, this monomer pre-emulsion was subjected to a treatment using a high-pressure homogenizer (PANDA 2K) at a pressure of 100 MPa for 2 passes, and 4 parts by weight of a 20 wt % emulsifying agent solution (anionic non-reactive emulsifying agent, trade name: HITENOL LA-16, manufactured by DAI-ICHI KOGYO SEIYAKU CO., LTD.) was added thereto (0.8 parts by weight by solid content), thereby obtaining a monomer emulsion.

### (Polymerization Step)

A reaction vessel equipped with a condenser tube, a nitrogen inlet tube, a thermometer, and a mixer was charged with the prepared monomer emulsion, then, after the reaction vessel atmosphere was replaced with nitrogen, the temperature was raised to 70° C., and the prepared monomer emulsion was polymerized for 3 hours, thereby obtaining an emulsion of an inorganic-polymer composite material having a solid content concentration of 13%.

### Example 7

A monomer emulsion was prepared in the same manner as in Example 6, except that the blending parts by weight of water was changed to 2014 parts by weight, the blending parts by weight of Lucentite SWN (hydrophilic layered clay mineral, maximum length of each layer: 50 nm, manufactured by Co-op Chemical Co., Ltd.) was changed to 100 parts by weight, and the blending parts by weight of the 20% dispersing agent solution (Shallol AN-103P, polymer dispersing agent, manufactured by DAI-ICHI KOGYO SEIYAKU CO., LTD.) was changed to 25 parts by weight (5 parts by weight by solid content) in the aqueous dispersion preparation step; and then the monomer emulsion was polymerized, thereby obtaining an emulsion of an inorganic-polymer composite material having a solid content concentration of 8%.

### Example 8

A monomer emulsion was prepared in the same manner as in Example 1, except that the blending parts by weight of water was changed to 658 parts by weight, and methyl methacrylate was used instead of butyl acrylate in the aqueous dispersion preparation step; and then the monomer emulsion was polymerized, thereby obtaining an emulsion of an inorganic-polymer composite material having a solid content concentration of 15%.

### Example 9

A monomer emulsion was prepared in the same manner as in Example 1, except that the blending parts by weight of water was changed to 658 parts by weight and isostearyl acrylate was used instead of butyl acrylate in the aqueous dispersion preparation step, and hexadecane was not used in the monomer emulsion preparation step; and then the monomer emulsion was polymerized, thereby obtaining an emulsion of an inorganic-polymer composite material having a solid content concentration of 15%.

### Example 10

A monomer emulsion was prepared in the same manner as in Example 1, except that the blending parts by weight of water was changed to 658 parts by weight, and styrene was used instead of butyl acrylate in the aqueous dispersion preparation step; and then the monomer emulsion was polymerized, thereby obtaining an emulsion of an inorganic-polymer composite material having a solid content concentration of 15%.

### Example 11

A monomer emulsion was prepared in the same manner as in Example 4, except that the blending parts by weight of water was changed to 504 parts by weight, 20 parts by weight of Kunipia F (hydrophilic layered clay mineral, maximum length of each layer: 300 nm, manufactured by KUNIMINE INDUSTRIES CO., LTD.) was used instead of 10 parts by weight of Lucentite SWN (hydrophilic layered clay mineral, maximum length of each layer: 50 nm, manufactured by Co-op Chemical Co., Ltd.) in the aqueous dispersion preparation step, and the 20 wt % emulsifying agent solution (anionic non-reactive emulsifying agent, trade name: HITENOL LA-16, manufactured by DAI-ICHI KOGYO SEIYAKU CO., LTD.) was not used in the monomer emulsion preparation step; and then the monomer emulsion was polymerized, thereby obtaining an emulsion of an inorganic-polymer composite material having a solid content concentration of 20%.

### Example 12

### (Aqueous Dispersion Preparation Step)

20 parts by weight of hydrophilic boron nitride particles (average primary particle size 20 nm) was added to 715 parts by weight of water, and the mixture was subjected to a treatment using an ultrasonic homogenizer for 3 minutes, thereby obtaining an aqueous dispersion.

### (Monomer Emulsion Preparation)

100 parts by weight of isostearyl acrylate, 5 parts by weight of hexadecane, 0.25 parts by weight of an initiator (dimethyl 2,2′-azobis(2-methylpropionate), oil-soluble azo-based initiator, trade name: V-601, manufactured by Wako Pure Chemical Industries, Ltd.) were mixed, thereby preparing an oil phase liquid.

Then, the oil phase liquid and the aqueous dispersion were mixed, and the mixture was stirred using a TK HOMO MIXER (manufactured by PRIMIX Corporation) for 1 minute at 6000 (l/min) to forcibly emulsify, thereby preparing a monomer pre-emulsion.

Then, this monomer pre-emulsion was subjected to a treatment using a high-pressure homogenizer (PANDA 2K) at a pressure of 100 MPa for 2 passes, and 5 parts by weight (1 part by weight by solid content) of a 20 wt % dispersing agent solution (polymer dispersing agent, trade name: Shallol AN-103P, manufactured by DAI-ICHI KOGYO SEIYAKU CO., LTD.) was added thereto, thereby obtaining a monomer emulsion.

### (Polymerization Step)

A reaction vessel equipped with a condenser tube, a nitrogen inlet tube, a thermometer, and a mixer was charged with the prepared monomer emulsion, then, after the reaction vessel atmosphere was replaced with nitrogen, the temperature was raised to 70° C., and the prepared monomer emulsion was polymerized for 3 hours, thereby obtaining an emulsion of an inorganic-polymer composite material having a solid content concentration of 20%.

### Example 13

An aqueous dispersion was prepared in the same manner as in Example 12, except that the blending parts by weight of water was changed to 942 parts by weight, and the blending parts by weight of the boron nitride particles was changed to 60 parts by weight in the aqueous dispersion preparation step; a monomer emulsion was prepared in the same manner as in Example 12, except that 0.03 parts by weight of 3-methacryloyloxypropyl-trimethoxysilane (KBM-503, manufactured by Shin-Etsu Chemical Co., Ltd.) was further added in the monomer emulsion preparation step; and then the monomer emulsion was polymerized, thereby obtaining an emulsion of an inorganic-polymer composite material having a solid content concentration of 30%.

### Example 14

### (Aqueous Dispersion Preparation Step)

20 parts by weight of hydrophilic titanium oxide (TTO-55D, average primary particle size 30 to 50 nm, manufactured by ISHIHARA SANGYO KAISHA, LTD.) was added to 517 parts by weight of water, and the mixture was subjected to a treatment using an ultrasonic homogenizer for 3 minutes, thereby obtaining an aqueous dispersion of titanium oxide.

### (Monomer Emulsion Preparation)

100 parts by weight of isostearyl acrylate, 5 parts by weight of hexadecane, 0.05 parts by weight of 3-methacryloyloxypropyl-trimethoxysilane (KBM-503, manufactured by Shin-Etsu Chemical Co., Ltd.), and 0.25 parts by weight of an initiator (dimethyl 2,2′-azobis(2-methylpropionate), oil-soluble azo-based initiator, trade name: V-601, manufactured by Wako Pure Chemical Industries, Ltd.) were mixed, thereby preparing an oil phase liquid.

Then, the oil phase liquid and the aqueous dispersion were mixed, and the mixture was stirred using a TK HOMO MIXER (manufactured by PRIMIX Corporation) for 1 minute at 6000 (l/min) to forcibly emulsify, thereby preparing a monomer pre-emulsion. Then, this monomer pre-emulsion was subjected to a treatment using a high-pressure homogenizer (PANDA 2K) at a pressure of 100 MPa for 2 passes, and 5 parts by weight (1 part by weight by solid content) of a 20 wt % dispersing agent solution (polymer dispersing agent, trade name: Shallol AN-103P, manufactured by DAI-ICHI KOGYO SEIYAKU CO., LTD.) and 25 parts by weight (5 parts by weight by solid content) of a 20 wt % dispersing agent solution (polymer dispersing agent, trade name: SN Dispersant 5045, manufactured by SAN NOPCO LIMITED) were added thereto, thereby obtaining a monomer emulsion.

### (Polymerization Step)

A reaction vessel equipped with a condenser tube, a nitrogen inlet tube, a thermometer, and a mixer was charged with the prepared monomer emulsion, then, after the reaction vessel atmosphere was replaced with nitrogen, the temperature was raised to 70° C., and the prepared monomer emulsion was polymerized for 3 hours, thereby obtaining an inorganic-polymer composite material having a solid content concentration of 20%.

### Example 15

### (Aqueous Dispersion Preparation)

84 parts by weight (15 parts by weight by solid content) of an aqueous dispersion of ATO (antimony-doped tin oxide) (SN-100S, solid content concentration 17.9%, bulk-form, average primary particle size 20 nm, manufactured by ISHIHARA SANGYO KAISHA, LTD.), 368 parts by weight of water, and 4.5 parts by weight of 3-methacryloyloxypropyl-trimethoxysilane (KBM-503, manufactured by Shin-Etsu Chemical Co., Ltd.) were added, and the mixture was stirred for 20 hours at room temperature. The pH of the mixture was adjusted to 4.0 by an aqueous solution of 5% acetic acid, thereby preparing an aqueous dispersion.

### (Monomer Emulsion Preparation Step)

100 parts by weight of methyl methacrylate, 3 parts by weight of hexadecane, 0.2 parts by weight of an initiator (azobisisobutyronitrile), and 0.25 parts by weight (0.05 parts by weight by solid content) of a 20 wt % emulsifying agent solution (anionic non-reactive emulsifying agent, trade name: HITENOL LA-16, manufactured by DAI-ICHI KOGYO SEIYAKU CO., LTD.) were added to the aqueous dispersion, and the mixture was stirred using a TK HOMO MIXER (manufactured by PRIMIX Corporation) for 1 minute at 6000 (l/min) to forcibly emulsify, thereby preparing a monomer pre-emulsion. Then, this monomer pre-emulsion was subjected to a treatment using a high-pressure homogenizer (nanomizer, manufactured by Yoshida Kikai Co., Ltd.) at a pressure of 150 MPa for 1 pass, thereby obtaining a monomer emulsion.

### (Polymerization Step)

A reaction vessel equipped with a condenser tube, a nitrogen inlet tube, a thermometer, and a mixer was charged with the prepared monomer emulsion, then, after the reaction vessel atmosphere was replaced with nitrogen, the temperature was raised to 70° C., and the prepared monomer emulsion was polymerized for 3 hours, thereby obtaining an emulsion of an inorganic-polymer composite material having a solid content concentration of 20%.

### Example 16

An aqueous dispersion was prepared, a monomer emulsion was prepared, and then the monomer emulsion was polymerized in the same manner as in Example 15, except that in the aqueous dispersion preparation step, the blending parts by weight of the ATO aqueous dispersion was changed to 50 parts by weight by solid content, the blending parts by weight of water was changed to 486 parts by weight, and the blending parts by weight of 3-methacryloyloxypropyl-trimethoxysilane was changed to 9.1 parts by weight, thereby obtaining an emulsion of an inorganic-polymer composite material having a solid content concentration of 18%.

### Example 17

An aqueous dispersion was prepared, a monomer emulsion was prepared, and then the monomer emulsion was polymerized in the same manner as in Example 15, except that in the aqueous dispersion preparation step, the blending parts by weight of the ATO aqueous dispersion was changed to 70 parts by weight by solid content, the blending parts by weight of water was changed to 486 parts by weight, and after the pH was adjusted to 4.0 by an aqueous solution of 5% acetic acid, 2.2 parts by weight (1 part by weight by solid content) of a 20 wt % dispersing agent solution (polycarboxylic acid-based dispersing agent, trade name: Shallol AN-103P, solid content concentration 45%, manufactured by DAI-ICHI KOGYO SEIYAKU CO., LTD.) was added thereto, thereby obtaining an emulsion of an inorganic-polymer composite material having a solid content concentration of 18%.

### Example 18

A monomer emulsion was prepared in the same manner as in Example 15, except that in the aqueous dispersion preparation step, the pH of the mixture was adjusted to 4.0 by an aqueous solution of 5% acetic acid, and 5 parts by weight (1 part by weight by solid content) of a 20 wt % dispersing agent solution (polymer dispersing agent, trade name: Shallol AN-103P, manufactured by DAI-ICHI KOGYO SEIYAKU CO., LTD.) was further added, and in the monomer emulsion preparation step, butyl acrylate was used instead of methyl methacrylate; and then the monomer emulsion was polymerized, thereby obtaining an emulsion of an inorganic-polymer composite material having a solid content concentration of 20%.

### Example 19

A monomer emulsion was prepared in the same manner as in Example 15, except that in the aqueous dispersion preparation step, after the pH of the mixture was adjusted to 4.0 by an aqueous solution of 5% acetic acid, the aqueous dispersion was subjected to further stir-mixing for 20 hours, and in the monomer emulsion preparation step, butyl acrylate was used instead of methyl methacrylate; and then the monomer emulsion was polymerized, thereby obtaining an emulsion of an inorganic-polymer composite material having a solid content concentration of 20%.

### Example 20

### (Aqueous Dispersion Preparation)

168 parts by weight (50 parts by weight by solid content) of an aqueous dispersion of ATO (antimony-doped tin oxide) (SN-100D, solid content concentration 29.7%, bulk-form, average primary particle size 20 nm, manufactured by ISHIHARA SANGYO KAISHA, LTD.), 167 parts by weight of water, and 3.8 parts by weight of 3-methacryloyloxypropyl-trimethoxysilane (ICBM-503, manufactured by Shin-Etsu Chemical Co., Ltd.) were added, and the pH of the mixture was adjusted to 4.0 by an aqueous solution of 5% acetic acid. The mixture was stirred for 20 hours at room temperature, and 15.0 parts by weight (3 parts by weight by solid content) of a 20 wt % dispersing agent solution (polymer dispersing agent, trade name: Shallol AN-103P, manufactured by DAI-ICHI KOGYO SEIYAKU CO., LTD.) was added thereto, thereby preparing an aqueous dispersion.

### (Monomer Emulsion Preparation Step)

100 parts by weight of butyl acrylate, 3 parts by weight of hexadecane, 0.2 parts by weight of an initiator (azobisisobutyronitrile), and 0.25 parts by weight (0.05 parts by weight by solid content) of a 20 wt % emulsifying agent solution (anionic non-reactive emulsifying agent, trade name: HITENOL LA-16, manufactured by DAI-ICHI KOGYO SEIYAKU CO., LTD.) was added to the aqueous dispersion, and the mixture was stirred using a TK HOMO MIXER (manufactured by PRIMIX Corporation) for 1 minute at 6000 (l/min) to forcibly emulsify, thereby preparing a monomer pre-emulsion. Then, this monomer pre-emulsion was subjected to a treatment using a high-pressure homogenizer (nanomizer, manufactured by Yoshida Kikai Co., Ltd.) at a pressure of 150 MPa for 1 pass, and 15 parts by weight (3 parts by weight by solid content) of a 20 wt % dispersing agent solution (polymer dispersing agent, trade name: SN Dispersant 5045, manufactured by SAN NOPCO LIMITED) was added thereto, thereby obtaining a monomer emulsion.

### (Polymerization Step)

A reaction vessel equipped with a condenser tube, a nitrogen inlet tube, a thermometer, and a mixer was charged with the prepared monomer emulsion, then, after the reaction vessel atmosphere was replaced with nitrogen, the temperature was raised to 70° C., and the prepared monomer emulsion was polymerized for 3 hours, thereby obtaining an emulsion of an inorganic-polymer composite material having a solid content concentration of 35%.

### Example 21

A monomer emulsion was prepared in the same manner as in Example 20, except that in the monomer emulsion preparation step, 100 parts by weight of 2-ethylhexyl acrylate was used instead of 100 parts by weight of butyl acrylate; and then the monomer emulsion was polymerized, thereby obtaining an emulsion of an inorganic-polymer composite material having a solid content concentration of 35%.

### Example 22

A monomer emulsion was prepared in the same manner as in Example 20, except that in the monomer emulsion preparation step, 100 parts by weight of lauryl methacrylate (dodecyl methacrylate) was used instead of 100 parts by weight of butyl acrylate; and then the monomer emulsion was polymerized, thereby obtaining an emulsion of an inorganic-polymer composite material having a solid content concentration of 35%.

### Example 23

A monomer emulsion was prepared in the same manner as in Example 20, except that in the monomer emulsion preparation step, 100 parts by weight of isostearyl acrylate (2-methylheptadecyl acrylate) was used instead of 100 parts by weight of butyl acrylate; and then the monomer emulsion was polymerized, thereby obtaining an emulsion of an inorganic-polymer composite material having a solid content concentration of 35%.

### Example 24

An aqueous dispersion was prepared, a monomer emulsion was prepared, and then the monomer emulsion was polymerized in the same manner as in Example 20, except that in the aqueous dispersion preparation step, the blending parts by weight of ATO (SN-100D, solid content concentration 29.7%, bulk-form, average primary particle size 20 nm, manufactured by ISHIHARA SANGYO KAISHA, LTD.) was changed to 673 parts by weight (200 parts by weight by solid content), the blending parts by weight of water was changed to 111 parts by weight, the blending parts by weight of 3-methacryloyloxypropyl-trimethoxysilane (KBM-503, manufactured by Shin-Etsu Chemical Co., Ltd.) was changed to 15.2 parts by weight, and the blending parts by weight of the 20 wt % dispersing agent solution (polymer dispersing agent, trade name: Shallol AN-103P, manufactured by DAI-ICHI KOGYO SEIYAKU CO., LTD.) was changed to 1 part by weight (0.2 parts by weight by solid content), thereby obtaining an emulsion of an inorganic-polymer composite material having a solid content concentration of 35%.

### Example 25

### (Aqueous Dispersion Preparation)

163 parts by weight (50 parts by weight by solid content) of an aqueous dispersion of titanium oxide (TTO-W-5, solid content concentration 30.7%, bulk-form, average primary particle size 50 nm, manufactured by ISHIHARA SANGYO KAISHA, LTD.), 172 parts by weight of water, 3.8 parts by weight of 3-methacryloyloxypropyl-trimethoxysilane (KBM-503, manufactured by Shin-Etsu Chemical Co., Ltd.) were added, and the pH of the mixture was adjusted to 4.0 by an aqueous solution of 5% acetic acid. The mixture was stirred for 20 hours at room temperature, and 15.0 parts by weight (3 parts by weight by solid content) of a 20 wt % dispersing agent solution (polymer dispersing agent, trade name: Shallol AN-103P, manufactured by DAI-ICHI KOGYO SEIYAKU CO., LTD.) was added thereto, thereby preparing an aqueous dispersion.

### (Monomer Emulsion Preparation Step)

100 parts by weight of butyl acrylate, 3 parts by weight of hexadecane, 0.2 parts by weight of an initiator (azobisisobutyronitrile), and 0.25 parts by weight (0.05 parts by weight by solid content) of a 20 wt % emulsifying agent solution (anionic non-reactive emulsifying agent, trade name: HITENOL LA-16, manufactured by DAI-ICHI KOGYO SEIYAKU CO., LTD.) were added to the aqueous dispersion, and the mixture was stirred using a TK HOMO MIXER (manufactured by PRIMIX Corporation) for 1 minute at 6000 (l/min) to forcibly emulsify, thereby preparing a monomer pre-emulsion. Then, this monomer pre-emulsion was subjected to a treatment using a high-pressure homogenizer (nanomizer, manufactured by Yoshida Kikai Co., Ltd.) at a pressure of 150 MPa for 1 pass, and 15 parts by weight (3 parts by weight by solid content) of a 20 wt % dispersing agent solution (polymer dispersing agent, trade name: SN Dispersant 5045, manufactured by SAN NOPCO LIMITED) was added thereto, thereby obtaining a monomer emulsion.

### (Polymerization Step)

A reaction vessel equipped with a condenser tube, a nitrogen inlet tube, a thermometer, and a mixer was charged with the prepared monomer emulsion, then, after the reaction vessel atmosphere was replaced with nitrogen, the temperature was raised to 70° C., and the prepared monomer emulsion was polymerized for 3 hours, thereby obtaining an emulsion of an inorganic-polymer composite material having a solid content concentration of 35%.

### Example 26

An aqueous dispersion was prepared, a monomer emulsion was prepared, and then the monomer emulsion was polymerized in the same manner as in Example 25, except that in the aqueous dispersion preparation step, 100 parts by weight (50 parts by weight by solid content) of an aqueous dispersion of alumina (NANOBYK-3600, alumina solid content concentration 50%, bulk-form, average primary particle size 40 nm, manufactured by BYK Japan KK) was used instead of 163 parts by weight (50 parts by weight by solid content) of the aqueous dispersion of titanium oxide (TTO-W-5, solid content concentration 30.7%, bulk-form, average primary particle size 50 nm, manufactured by ISHIHARA SANGYO KAISHA, LTD.), and the blending parts by weight of water was changed to 235 parts by weight, thereby obtaining an emulsion of an inorganic-polymer composite material having a solid content concentration of 35%.

### Example 27

An aqueous dispersion was prepared, a monomer emulsion was prepared, and then the monomer emulsion was polymerized in the same manner as in Example 25, except that in the aqueous dispersion preparation step, 285 parts by weight (50 parts by weight by solid content) of an aqueous dispersion of alumina (aluminasol 100, alumina solid content concentration 10.3%, needle-form, maximum length 300 nm, manufactured by NISSAN CHEMICAL INDUSTRIES, LTD.) was used instead of 163 parts by weight (50 parts by weight by solid content) of the aqueous dispersion of titanium oxide (TTO-W-5, solid content concentration 30.7%, bulk-form, average primary particle size 50 nm, manufactured by ISHIHARA SANGYO KAISHA, LTD.), the blending parts by weight of water was changed to 67 parts by weight, and the blending parts by weight of 3-methacryloyloxypropyl-trimethoxysilane (KBM-503, manufactured by Shin-Etsu Chemical Co., Ltd.) was changed to 15.3 parts by weight, thereby obtaining an emulsion of an inorganic-polymer composite material having a solid content concentration of 35%.

### Example 28

An aqueous dispersion was prepared, a monomer emulsion was prepared, and then the monomer emulsion was polymerized in the same manner as in Example 25, except that in the aqueous dispersion preparation step, 100 parts by weight (50 parts by weight by solid content) of an aqueous dispersion of alumina (NANOBYK-3600, alumina solid content concentration 50%, manufactured by BYK Japan KK) and 485 parts by weight (50 parts by weight by solid content) of an aqueous dispersion of alumina (aluminasol 100, alumina solid content concentration 10.3%, needle-form, maximum length 300 nm, manufactured by NISSAN CHEMICAL INDUSTRIES, LTD.) were used instead of 163 parts by weight (50 parts by weight by solid content) of the aqueous dispersion of titanium oxide (TTO-55D, bulk-form, average primary particle size 30 to 50 nm, manufactured by ISHIHARA SANGYO KAISHA, LTD.), the blending parts by weight of water was changed to 70 parts by weight, and the blending parts by weight of 3-methacryloyloxypropyl-trimethoxysilane (KBM-503, manufactured by Shin-Etsu Chemical Co., Ltd.) was changed to 16.2 parts by weight, thereby obtaining an emulsion of an inorganic-polymer composite material having a solid content concentration of 35%.

### Example 29

An aqueous dispersion was prepared, a monomer emulsion was prepared, and then the monomer emulsion was polymerized in the same manner as in Example 25, except that in the aqueous dispersion preparation step, 50 parts by weight of silicon carbide powder (β-SiC, average primary particle size 30 nm, manufactured by SUMITOMO OSAKA CEMENT Co., Ltd.) was used instead of 163 parts by weight (50 parts by weight by solid content) of the aqueous dispersion of titanium oxide (TTO-55D, bulk-form, average primary particle size 30 to 50 nm, manufactured by ISHIHARA SANGYO KAISHA, LTD.), the blending parts by weight of water was changed to 282 parts by weight, and the blending parts by weight of 3-methacryloyloxypropyl-trimethoxysilane (KBM-503, manufactured by Shin-Etsu Chemical Co., Ltd.) was changed to 1.9 parts by weight, thereby obtaining an emulsion of an inorganic-polymer composite material having a solid content concentration of 35%.

### Example 30

An aqueous dispersion was prepared, a monomer emulsion was prepared, and then the monomer emulsion was polymerized in the same manner as in Example 25, except that in the aqueous dispersion preparation step, 50 parts by weight of diamond powder (HHM-A-1/10 μm, average primary particle size 100 nm, manufactured by Techno Rise Corporation) was used instead of 163 parts by weight (50 parts by weight by solid content) of the aqueous dispersion of titanium oxide (TTO-55D, bulk-form, average primary particle size 30 to 50 nm, manufactured by ISHIHARA SANGYO KAISHA, LTD.), the blending parts by weight of water was changed to 279 parts by weight, and the blending parts by weight of 3-methacryloyloxypropyl-trimethoxysilane (KBM-503, manufactured by Shin-Etsu Chemical Co., Ltd.) was changed to 0.5 parts by weight, thereby obtaining an emulsion of an inorganic-polymer composite material having a solid content concentration of 35%.

### Example 31

### (Aqueous Dispersion Preparation Step)

10 parts by weight of Lucentite SWN (layered clay mineral, manufactured by Co-op Chemical Co., Ltd.) was added to 279 parts by weight of water, and the mixture was allowed to stand for 24 hours. 2.5 parts by weight (0.5 parts by weight by solid content) of a 20% dispersing agent solution (Shallol AN-103P, polymer dispersing agent, manufactured by DAI-ICHI KOGYO SEIYAKU CO., LTD.) was added thereto, and the mixture was subjected to stir-mixing for 3 minutes with an ultrasonic homogenizer, thereby obtaining an aqueous dispersion.

### (Monomer Dispersion Liquid Preparation Step)

100 parts by weight of butyl acrylate, 5 parts by weight of hexadecane, 0.05 parts by weight of 3-methacryloyloxypropyl-trimethoxysilane (ICBM-503, manufactured by Shin-Etsu Chemical Co., Ltd.), 0.25 parts by weight of an initiator (dimethyl 2,2′-azobis(2-methylpropionate), oil-soluble azo-based initiator, trade name: V-601, manufactured by Wako Pure Chemical Industries, Ltd.) were mixed, thereby preparing an oil phase liquid. 5 parts of Aerosil R8200 (fumed silica, primary particle size 12 nm, hexamethyldisilazane treatment, manufactured by Nippon Aerosil Co., Ltd.) was added thereto, and the mixture was subjected to stir-mixing for 3 minutes with an ultrasonic homogenizer, thereby obtaining an oil phase liquid containing the monomer dispersion liquid.

### (Monomer Emulsion Preparation Step)

Then, the oil phase liquid and the aqueous dispersion were mixed, and the mixture was stirred using a TK HOMO MIXER (manufactured by PRIMIX Corporation) for 1 minute at 6000 (l/min) to forcibly emulsify, thereby preparing a monomer pre-emulsion. Then, this monomer pre-emulsion was subjected to a treatment using a high-pressure homogenizer (PANDA 2K) at a pressure of 100 MPa for 2 passes, thereby obtaining a monomer emulsion.

### (Polymerization Step)

A reaction vessel equipped with a condenser tube, a nitrogen inlet tube, a thermometer, and a mixer was charged with the prepared monomer emulsion, then, after the reaction vessel atmosphere was replaced with nitrogen, the temperature was raised to 70° C., and the prepared monomer emulsion was polymerized for 3 hours, thereby obtaining an emulsion of an inorganic composite water-dispersion type resin of a 30% solid content concentration.

### Example 32

### (Aqueous Dispersion Preparation)

168 parts by weight (50 parts by weight by solid content) of an aqueous dispersion of ATO (antimony-doped tin oxide) (SN-100D, solid content concentration 29.7%, manufactured by ISHIHARA SANGYO KAISHA, LTD.), 168 parts by weight of water, 3.8 parts by weight of 3-methacryloyloxypropyl-trimethoxysilane (KBM-503, manufactured by Shin-Etsu Chemical Co., Ltd.) were added, and the pH of the mixture was adjusted to 4.0 by an aqueous solution of 5% acetic acid. The mixture was stirred for 20 hours at room temperature, and 15.0 parts by weight (3 parts by weight by solid content) of a 20 wt % dispersing agent solution (polymer dispersing agent, trade name: Shallol AN-103P, manufactured by DAI-ICHI KOGYO SEIYAKU CO., LTD.) was added thereto, thereby preparing an aqueous dispersion.

### (Monomer Dispersion Liquid Preparation Step)

To a liquid in which 100 parts by weight of butyl acrylate, 3 parts by weight of hexadecane, and 0.2 parts by weight of an initiator (azobisisobutyronitrile) were mixed, 5 parts of Aerosil R8200 (fumed silica, primary particle size 12 nm, hexamethyldisilazane treatment, manufactured by Nippon Aerosil Co., Ltd.) was added, and the mixture was subjected to stir-mixing for 3 minutes with an ultrasonic homogenizer, thereby obtaining an oil phase liquid containing a monomer dispersion liquid.

### (Monomer Emulsion Preparation Step)

Then, the oil phase liquid and 0.25 parts by weight (0.05 parts by weight by solid content) of a 20 wt % emulsifying agent solution (anionic non-reactive emulsifying agent, trade name: HITENOL LA-16, manufactured by DAI-ICHI KOGYO SEIYAKU CO., LTD.) were added to the aqueous dispersion, and the mixture was stirred using a TK HOMO MIXER (manufactured by PRIMIX Corporation) for 1 minute at 6000 (l/min) to forcibly emulsify, thereby preparing a monomer pre-emulsion. Then, this monomer pre-emulsion was subjected to a treatment using a high-pressure homogenizer (nanomizer, manufactured by Yoshida Kikai Co., Ltd.) at a pressure of 150 MPa for 1 pass, thereby obtaining a monomer emulsion.

### (Polymerization Step)

A reaction vessel equipped with a condenser tube, a nitrogen inlet tube, a thermometer, and a mixer was charged with the prepared monomer emulsion, then, after the reaction vessel atmosphere was replaced with nitrogen, the temperature was raised to 70° C., and the prepared monomer emulsion was polymerized for 3 hours, thereby obtaining an emulsion of an inorganic composite water-dispersion type resin of a 35% solid content concentration.

### Referential Comparative Example 1

A monomer emulsion was prepared and then the monomer emulsion was polymerized in the same manner as in Example 1, except that in the monomer emulsion preparation step, the 20 wt % emulsifying agent solution (anionic non-reactive emulsifying agent, trade name: HITENOL LA-16, manufactured by DAI-ICHI KOGYO SEIYAKU CO., LTD.) was not used, thereby obtaining an emulsion of an inorganic-polymer composite material having a solid content concentration of 20%.

### Referential Comparative Example 2

A monomer emulsion was prepared and then the monomer emulsion was polymerized in the same manner as in Example 1, except that in the monomer emulsion preparation step, 0.03 parts by weight of 3-methacryloyloxypropyl-trimethoxysilane (KBM-503, manufactured by Shin-Etsu Chemical Co., Ltd.) was further added to the oil phase liquid, and the monomer pre-emulsion was not subjected to stir-mixing using the high-pressure homogenizer (PANDA 2K) to be emulsified, thereby obtaining an emulsion of an inorganic-polymer composite material having a solid content concentration of 20%.

### Referential Comparative Example 3

### (Aqueous Dispersion Preparation Step)

250 parts by weight of Lucentite SWN (hydrophilic layered clay mineral, maximum length of each layer: 50 nm, manufactured by Co-op Chemical Co., Ltd.) was added to 4263 parts by weight of water, and the mixture was allowed to stand for 24 hours. 62.5 parts by weight (12.5 parts by weight by solid content) of a 20% dispersing agent solution (Shallol AN-130P, polymer dispersing agent, manufactured by DAI-ICHI KOGYO SEIYAKU CO., LTD.) was added thereto, and the mixture was subjected to stir-mixing for 3 minutes with an ultrasonic homogenizer, thereby obtaining an aqueous dispersion.

### (Monomer Emulsion Preparation Step)

100 parts by weight of butyl acrylate, 5 parts by weight of hexadecane, 0.03 parts by weight of 3-methacryloxypropyl-trimethoxysilane (KBM-503, manufactured by Shin-Etsu Chemical Co., Ltd.), 0.25 parts by weight of an initiator (dimethyl 2,2′-azobis(2-methylpropionate), oil-soluble azo-based initiator, trade name: V-601, manufactured by Wako Pure Chemical Industries, Ltd.) were mixed, thereby preparing an oil phase liquid.

Then, the oil phase liquid and the aqueous dispersion were mixed, and the mixture was stirred using a TK HOMO MIXER (manufactured by PRIMIX Corporation) for 1 minute at 6000 (l/min) to forcibly emulsify, thereby preparing a monomer pre-emulsion.

Then, this monomer pre-emulsion was subjected to a treatment using a high-pressure homogenizer (PANDA 2K) at a pressure of 100 MPa for 2 passes, and 4 parts by weight (0.8 parts by weight by solid content) of a 20 wt % emulsifying agent solution (anionic non-reactive emulsifying agent, trade name: HITENOL LA-16, manufactured by DAI-ICHI KOGYO SEIYAKU CO., LTD.) was added thereto, thereby obtaining a monomer emulsion.

### (Polymerization Step)

A reaction vessel equipped with a condenser tube, a nitrogen inlet tube, a thermometer, and a mixer was charged with the prepared monomer emulsion, then, after the reaction vessel atmosphere was replaced with nitrogen, the temperature was raised to 70° C., and the prepared monomer emulsion was polymerized for 3 hours, thereby obtaining an emulsion of an inorganic-polymer composite material having a solid content concentration of 8%.

### Referential Comparative Example 4

An emulsion of an inorganic-polymer composite material having a solid content concentration of 8% was obtained in the same manner as in Referential Comparative Example 3, except that in the aqueous dispersion preparation step, the blending parts by weight of Lucentite SWN (hydrophilic layered clay mineral, maximum length of each layer: 50 nm, manufactured by Co-op Chemical Co., Ltd.) was changed to 3 parts by weight, and the blending parts by weight of water was changed to 587 parts by weight.

### Referential Comparative Example 5

A monomer emulsion was prepared and then the monomer emulsion was polymerized in the same manner as in Example 12, except that in the monomer emulsion preparation step, the 20 wt % dispersing agent solution (polymer dispersing agent, trade name: Shallol AN-103P, manufactured by DAI-ICHI KOGYO SEIYAKU CO., LTD.) was not used, thereby obtaining an emulsion of an inorganic-polymer composite material having a solid content concentration of 20%.

### Comparative Example 1

### (Aqueous Dispersion Preparation Step)

15 parts by weight (3 parts by weight by solid content concentration) of a 20 wt % emulsifying agent solution (anionic non-reactive emulsifying agent, trade name: HITENOL LA-16, manufactured by DAI-ICHI KOGYO SEIYAKU CO., LTD.) was added to 106 parts by weight of water, thereby preparing an aqueous dispersion.

### (Monomer Emulsion Preparation Step)

100 parts by weight of butyl acrylate, 5 parts by weight of hexadecane, 0.03 parts by weight of 3-methacryloyloxypropyl-trimethoxysilane (KBM-503, manufactured by Shin-Etsu Chemical Co., Ltd.), and 0.25 parts by weight of an initiator (dimethyl 2,2′-azobis(2-methylpropionate), oil-soluble azo-based initiator, trade name: V-601, manufactured by Wako Pure Chemical Industries, Ltd.) were mixed, thereby preparing an oil phase liquid.

Then, this oil phase liquid and the aqueous dispersion were mixed, and the mixture was stirred using a TK HOMO MIXER (manufactured by PRIMIX Corporation) for 1 minute at 6000 (l/min) to forcibly emulsify, thereby preparing a monomer pre-emulsion. Then, this monomer pre-emulsion was subjected to a treatment using a high-pressure homogenizer (PANDA 2K) at a pressure of 100 MPa for 2 passes, thereby obtaining a monomer emulsion.

### (Polymerization Step)

A reaction vessel equipped with a condenser tube, a nitrogen inlet tube, a thermometer, and a mixer was charged with the prepared monomer emulsion, then, after the reaction vessel atmosphere was replaced with nitrogen, the temperature was raised to 70° C., and the prepared monomer emulsion was polymerized for 3 hours, thereby obtaining a polymer emulsion having a solid content concentration of 50%.

### Comparative Example 2

### (Aqueous Dispersion Preparation Step)

A container was charged with 90 parts by weight of water and 10 parts by weight of Lucentite SWN (hydrophilic layered clay mineral, maximum length of each layer: 50 nm, manufactured by Co-op Chemical Co., Ltd.), and the mixture was allowed to stand for 24 hours. To the mixture, sodium hexametaphosphate (dispersing agent, manufactured by Wako Pure Chemical Industries, Ltd.) adjusted to 10% was added such that the solid content concentration of the sodium hexametaphosphate was 10 wt % relative to Lucentite SWN. Then, the mixture was subjected to stir-mixing for 3 minutes with an ultrasonic homogenizer, thereby preparing an aqueous dispersion of 10% layered clay mineral.

### (Monomer Emulsion Preparation Step)

To the polymer emulsion having a solid content concentration of 50% prepared in Comparative Example 1, the aqueous dispersion of 10% layered clay mineral was added such that the layered clay mineral is 10 parts by weight relative to 100 parts by weight of the polymer composite material and the mixture was stirred, thereby obtaining an emulsion of an inorganic-polymer composite material.

### Comparative Example 3

An emulsion of an inorganic-polymer composite material was obtained in the same manner as in Comparative Example 2, except that in the aqueous dispersion preparation step, the solid content of sodium hexamethphosphate (dispersing agent, manufactured by Wako Pure Chemical Industries, Ltd.) was changed to 20 parts by weight.

### Comparative Example 4

A monomer emulsion was prepared, and then an emulsion of an inorganic-polymer composite material having a solid content concentration of 50% was obtained in the same manner as in Comparative Example 2, except that in the aqueous dispersion preparation step, Lucentite SPN (hydrophobic layered clay mineral, maximum length of each layer: 50 nm, manufactured by Co-op Chemical Co., Ltd.) was used instead of Lucentite SWN (hydrophilic layered clay mineral, maximum length of each layer: 50 nm, manufactured by Co-op Chemical Co., Ltd.).

### Comparative Example 5

A monomer emulsion was prepared, and then an emulsion of an inorganic-polymer composite material having a solid content concentration of 50% was obtained in the same manner as in Comparative Example 1, except that in the aqueous dispersion preparation step, Lucentite SPN (hydrophobic layered clay mineral, maximum length of each layer: 50 nm, manufactured by Co-op Chemical Co., Ltd.) was used instead of Lucentite SWN (hydrophilic layered clay mineral, maximum length of each layer: 50 nm, manufactured by Co-op Chemical Co., Ltd.), and sodium hexamethphosphate (dispersing agent, manufactured by Wako Pure Chemical Industries, Ltd.) were added so that the solid content concentration of the sodium hexamethphosphate relative to Lucentite SWN was 20 wt %.

### Comparative Example 6

### (Monomer Emulsion Preparation Step)

100 parts by weight of butyl acrylate, 3 parts by weight of hexadecane, 0.2 parts by weight of an initiator (azobisisobutyronitrile), 1 part by weight (0.2 parts by weight by solid content) of a 20 wt % emulsifying agent solution (anionic non-reactive emulsifying agent, trade name: HITENOL LA-16, manufactured by DAI-ICHI KOGYO SEIYAKU CO., LTD.), and 309 parts by weight of water were added, and the mixture was stirred for 1 minute using a homogenizer (manufactured by PRIMIX Corporation) at 6000 (l/min) to forcibly emulsify, thereby preparing a monomer pre-emulsion. Then, this monomer pre-emulsion was subjected to a treatment using a high-pressure homogenizer (nanomizer, manufactured by Yoshida Kikai Co., Ltd.) at a pressure of 150 MPa for 1 pass, thereby obtaining a monomer emulsion.

### (Polymerization Step)

A reaction vessel equipped with a condenser tube, a nitrogen inlet tube, a thermometer, and a mixer was charged with the prepared monomer dispersion liquid, then, after the reaction vessel atmosphere was replaced with nitrogen, the temperature was raised to 70° C., and the prepared monomer emulsion was polymerized for 3 hours, thereby obtaining an emulsion of an inorganic-polymer composite material having a solid content concentration of 23%.

Thereafter, 75 parts by weight (15 parts by weight by solid content) of an aqueous dispersion (SN-100S, solid content concentration 17.9%, manufactured by ISHIHARA SANGYO KAISHA, LTD.) was added to the emulsion and stirred, thereby obtaining an emulsion of an inorganic-polymer composite material.

### Comparative Example 7

### (Aqueous Dispersion Preparation Step)

10 parts by weight of Lucentite SWN (hydrophilic layered clay mineral, maximum length of each layer: 50 nm, manufactured by Co-op Chemical Co., Ltd.) was added to 372 parts by weight of water, and allowed to stand for 24 hours. Furthermore, the mixture was stirred for 24 hours, thereby preparing an aqueous dispersion.

### (Monomer Emulsion Preparation Step)

14 parts by weight of dodecyl trimethyl ammonium bromide (hydrophobizing treatment agent, manufactured by Wako Pure Chemical Industries, Ltd.) was dissolved in 126 parts by weight of water, and the mixture was added to the aqueous dispersion.

Then, an oil phase liquid in which 100 parts by weight of butyl acrylate and 0.5 parts by weight of azobisisobutyronitrile were mixed was added thereto and the mixture was stirred at 23° C. for 24 hours, thereby preparing a monomer emulsion.

### (Polymerization Step)

A reaction vessel equipped with a condenser tube, a nitrogen inlet tube, a thermometer, and a mixer was charged with the prepared monomer emulsion, then, after the reaction vessel atmosphere was replaced with nitrogen, the temperature was raised to 70° C., and the prepared monomer emulsion was polymerized for 3 hours, thereby obtaining an emulsion of an inorganic-polymer composite material having a solid content concentration of 20%.

### Comparative Example 8

### (Aqueous Dispersion Preparation Step)

To 155 parts by weight of water, 2.5 parts by weight (0.5 parts by weight in solid content concentration) of a 20 wt % emulsifying agent solution (anionic non-reactive emulsifying agent, trade name: HITENOL LA-16, manufactured by DAI-ICHI KOGYO SEIYAKU CO., LTD.), and 2.5 parts by weight (0.5 parts by weight by solid content) of a 20% dispersing agent solution (Shallot AN-103P, polymer dispersing agent, manufactured by DAI-ICHI KOGYO SEIYAKU CO., LTD.) were added, and further acetic acid was added, thereby preparing an aqueous dispersion with a pH of 4.0.

### (Monomer Emulsion Preparation Step)

100 parts by weight of butyl acrylate, 5 parts by weight of hexadecane, 0.05 parts by weight of 3-methacryloyloxypropyl-trimethoxysilane (KBM-503, manufactured by Shin-Etsu Chemical Co., Ltd.), and 0.25 parts by weight of an initiator (dimethyl 2,2′-azobis(2-methylpropionate), oil-soluble azo-based initiator, trade name: V-601, manufactured by Wako Pure Chemical Industries, Ltd.) were mixed, thereby preparing an oil phase liquid.

Then, this oil phase liquid and the aqueous dispersion were mixed, and the mixture was stirred using a TK HOMO MIXER (manufactured by PRIMIX Corporation) for 1 minute at 6000 (l/min) to forcibly emulsify, thereby preparing a monomer pre-emulsion. Then, this monomer pre-emulsion was subjected to a treatment using a high-pressure homogenizer (PANDA 2K) at a pressure of 100 MPa for 2 passes, and 2.5 parts by weight (0.5 parts by weight by solid content) of a 20 wt % dispersing agent solution (polymer dispersing agent, trade name: SN Dispersant 5045, manufactured by SAN NOPCO LIMITED) was added thereto, thereby obtaining a monomer emulsion.

### (Polymerization Step)

A reaction vessel equipped with a condenser tube, a nitrogen inlet tube, a thermometer, and a mixer was charged with the prepared monomer emulsion, then, after the reaction vessel atmosphere was replaced with nitrogen, the temperature was raised to 70° C., and the prepared monomer emulsion was polymerized for 3 hours, thereby obtaining a polymer emulsion having a solid content concentration of 40%.

Thereafter, 1.5 parts by weight by solid content of a 20 wt % emulsifying agent solution (anionic non-reactive emulsifying agent, trade name: HITENOL LA-16, manufactured by DAI-ICHI KOGYO SEIYAKU CO., LTD.) relative to 100 parts by weight of the prepared polymer emulsion by solid content was added, and further 0.3 parts by weight by solid content of a viscosity adjuster (trade name SN Thickner 634, manufactured by SAN NOPCO LIMITED) was added to the polymer emulsion, thereby obtaining a polymer emulsion having a solid content concentration of 40%.

### Comparative Example 9

### (Aqueous Dispersion Preparation Step)

To 163 parts by weight of water, 2.5 parts by weight (0.5 parts by weight in solid content concentration) of a 20 wt % emulsifying agent solution (anionic non-reactive emulsifying agent, trade name: HITENOL LA-16, manufactured by DAI-ICHI KOGYO SEIYAKU CO., LTD.), and 2.5 parts by weight (0.5 parts by weight by solid content) of a 20% dispersing agent solution (Shallol AN-103P, polymer dispersing agent, manufactured by DAI-ICHI KOGYO SEIYAKU CO., LTD.) were added, and further acetic acid was added, thereby preparing an aqueous dispersion with a pH of 4.0.

### (Monomer Dispersion Liquid Preparation Step)

100 parts by weight of butyl acrylate, 5 parts by weight of hexadecane, 0.05 parts by weight of 3-methacryloyloxypropyl-trimethoxysilane (KBM-503, manufactured by Shin-Etsu Chemical Co., Ltd.), and 0.25 parts by weight of an initiator (dimethyl 2,2′-azobis(2-methylpropionate), oil-soluble azo-based initiator, trade name: V-601, manufactured by Wako Pure Chemical Industries, Ltd.) were mixed, thereby preparing an oil phase liquid. 5 parts by weight of Aerosil R8200(fumed silica, average primary particle size 12 nm, hexamethyldisilazane treatment, manufactured by Nippon Aerosil Co., Ltd.) was added to the oil phase liquid, and the mixture was subjected to stir-mixing for 3 minutes using an ultrasonic homogenizer, thereby obtaining an oil phase liquid containing a monomer dispersion liquid.

### (Monomer Emulsion Preparation Step)

Then, the oil phase liquid and the aqueous dispersion were mixed, and the mixture was stirred using a TK HOMO MIXER (manufactured by PRIMIX Corporation) for 1 minute at 6000 (l/min) to forcibly emulsify, thereby preparing a monomer pre-emulsion. Then, this monomer pre-emulsion was subjected to a treatment using a high-pressure homogenizer (PANDA 2K) at a pressure of 100 MPa for 2 passes, thereby obtaining a monomer emulsion.

### (Polymerization Step)

A reaction vessel equipped with a condenser tube, a nitrogen inlet tube, a thermometer, and a mixer was charged with the prepared monomer emulsion, then, after the reaction vessel atmosphere was replaced with nitrogen, the temperature was raised to 70° C., and the prepared monomer emulsion was polymerized for 3 hours, thereby obtaining an emulsion of an inorganic-polymer composite material having a solid content concentration of 40%.

### Comparative Example 10

### (Aqueous Dispersion Preparation Step)

10 parts by weight of Aerosil R8200(fumed silica, average primary particle size 12 nm, hexamethyldisilazane treatment, manufactured by Nippon Aerosil Co., Ltd.) was added to 70 parts by weight of water, and 20 parts by weight (10 parts by weight by solid content) of a 50% dispersing agent solution (EFKA 4550, polyacrylic acid-based dispersing agent, manufactured by Ciba Specialty Chemicals Inc.) was added thereto. The mixture was subjected to stir-mixing for 3 minutes with an ultrasonic homogenizer, thereby obtaining an aqueous dispersion having a solid content concentration of 10%.

### (Inorganic-Polymer Composite Material Preparation Step)

1.5 parts by weight by solid content of a 20 wt % emulsifying agent solution (anionic non-reactive emulsifying agent, trade name: HITENOL LA-16, manufactured by DAI-ICHI KOGYO SEIYAKU CO., LTD.) relative to 100 parts by weight by solid content of the polymer emulsion prepared in Comparative Example 8 was added. To the mixture, 5 parts by weight by solid content of the aqueous dispersion was added, and further 0.3 parts by weight by solid content of a viscosity adjuster (trade name SN Thickner 634, manufactured by SAN NOPCO LIMITED) was added, thereby obtaining an emulsion of an inorganic-polymer composite material having a solid content concentration of 40%.

### Comparative Example 11

### (Aqueous Dispersion Preparation Step)

5 parts by weight of Lucentite SWN (hydrophilic layered clay mineral, maximum length of each layer: 50 nm, manufactured by Co-op Chemical Co., Ltd.) was added to 92.5 parts by weight of water, and allowed to stand for 24 hours. 5 parts by weight (1 part by weight by solid content) of a 20% dispersing agent solution (Shallol AN-103P, polymer dispersing agent, manufactured by DAI-ICHI KOGYO SEIYAKU CO., LTD.) was added thereto, and the mixture was subjected to stir-mixing for 3 minutes with an ultrasonic homogenizer, thereby obtaining an aqueous dispersion of layered clay mineral having a solid content concentration of 5%.

### (Inorganic-Polymer Composite Material Preparation Step)

1.5 parts by weight by solid content of a 20 wt % emulsifying agent solution (anionic non-reactive emulsifying agent, trade name: HITENOL LA-16, manufactured by DAI-ICHI KOGYO SEIYAKU CO., LTD.) relative to 100 parts by weight by solid content of the polymer emulsion prepared in Comparative Example 8 was added. To the mixture, 5 parts by weight by solid content of the aqueous dispersion was added, and further 0.3 parts by weight by solid content of a viscosity adjuster (trade name SN Thickner 634, manufactured by SAN NOPCO LIMITED) was added, thereby obtaining an emulsion of an inorganic-polymer composite material having a solid content concentration of 40%.

TABLE 1

| | | | | Ex. 1 | Ex. 2 | Ex. 3 | Ex. 4 | Ex. 6 | Ex. 6 | Ex. 7 | Ex. 8 |
|---|---|---|---|---|---|---|---|---|---|---|---|
| Blending | Monomer Component | | BA | 100 | 100 | 100 | 100 | 100 | 100 | 100 | — |
| Formu- | | | St | — | — | — | — | — | — | — | — |
| lation | | | ISTA | — | — | — | — | — | — | — | — |
| | | | MMA | — | — | — | — | — | — | — | 100 |
| | | | 2EHA | — | — | — | — | — | — | — | — |
| | | | LMA | — | — | — | — | — | — | — | — |
| | | | KBM-503 | — | 0.03 | 0.03 | 0.03 | 0.03 | 0.03 | 0.03 | — |
| | Hydrophobic Compound | | Hexadecane | 5 | 5 | 5 | 5 | 5 | 5 | 5 | 5 |
| | Initiator | | V-601 | 0.25 | 0.25 | 0.25 | 0.25 | 0.25 | 0.25 | 0.25 | 0.25 |
| | | | AIBN | — | — | — | — | — | — | — | — |
| | Hydrophobic Inorganic | | Aerosil R8200 | — | — | — | — | — | — | — | — |
| | Compound | | | | | | | | | | |
| | Hydrophilic | Layered | Lucentite | 10 | 10 | 20 | 5 | 10 | 50 | 100 | 10 |
| | Inorganic | | SWN | | | | | | | | |
| | Compound | | Kunipia F | — | — | — | — | — | — | — | — |
| | | | Lucentite SPN | — | — | — | — | — | — | — | — |
| | | Bulk | BN-20 | — | — | — | — | — | — | — | — |
| | | | TTO-55D | — | — | — | — | — | — | — | — |
| | | | SN-100S* | — | — | — | — | — | — | — | — |
| | | | SN-100D* | — | — | — | — | — | — | — | — |
| | | | TTO-W-5* | — | — | — | — | — | — | — | — |
| | | | NANOBYK- | — | — | — | — | — | — | — | — |
| | | | 3600* | | | | | | | | |
| | | | β-Sic | — | — | — | — | — | — | — | — |
| | | | HHM-A-1/10 μm | — | — | — | — | — | — | — | — |
| | | Needle | Aluminasol | — | — | — | — | — | — | — | — |
| | | | 100* | | | | | | | | |
| | Surface | Coupling | KBM-503 | — | — | — | — | — | — | — | — |
| | Treatment | Agent | | | | | | | | | |
| | Agent | Hydro- | Swelling Agent | — | — | — | — | — | — | — | — |
| | | phobizing | | | | | | | | | |
| | | Treatment | | | | | | | | | |
| | | Agent | | | | | | | | | |
| | Surfactant | Emulsifying- | LA-16* | 1 | 1 | 1 | 0.5 | — | 0.8 | 0.8 | 1 |
| | | Agent | | | | | | | | | |
| | | Dispersing | Shallol AN- | — | — | — | 1 | 1 | 2.5 | 5 | — |
| | | Agent | 103P* | | | | | | | | |
| | | | SN Dispersant | — | — | — | — | — | — | — | — |
| | | | 5045* | | | | | | | | |
| | | | Hexametaphosphate | — | — | — | — | — | — | — | — |
| | | | Na | | | | | | | | |
| | | | EFKA 4550* | — | — | — | — | — | — | — | — |
| | Additive | Viscosity | SN Thickner | — | — | — | — | — | — | — | — |
| | Adjuster | | 634 | | | | | | | | |

| | | | | | | | | |
|---|---|---|---|---|---|---|---|---|
| Water (In Aqueous Dispersion) | 464 | 464 | 504 | 631 | 271 | 1056 | 2014 | 658 |
| Solid Content Concentration Upon | 20 | 20 | 20 | 15 | 30 | 13 | 8 | 15 |
| Polymerization [%] | | | | | | | | |

*solid content amount

TABLE 2

| | | | | | Ex. | Ex. | Ex. | Ex. | Ex. | Ex. | Ex. |
|---|---|---|---|---|---|---|---|---|---|---|---|
| | | | | Ex. 9 | 10 | 11 | 12 | 13 | 14 | 15 | 16 |
| Blending | Monomer Component | | BA | — | — | 100 | — | — | — | — | — |
| Formu- | | | St | — | 100 | — | — | — | — | — | — |
| lation | | | ISTA | 100 | — | | 100 | 100 | 100 | — | — |
| | | | MMA | — | — | — | — | — | — | 100 | 100 |
| | | | 2EHA | — | — | — | — | — | — | — | — |
| | | | LMA | — | — | — | — | — | — | — | — |
| | | | KBM-503 | — | — | 0.03 | — | 0.03 | 0.05 | — | — |
| | Hydrophobic Compound | | Hexadecane | — | 5 | 5 | 5 | 5 | 5 | 3 | 3 |
| | Initiator | | V-601 | 0.25 | 0.25 | 0.25 | 0.25 | 0.25 | 0.25 | — | — |
| | | | AIBN | — | — | — | — | — | — | 0.2 | 0.2 |
| | Hydrophobic Inorganic | | Aerosil R8200 | — | — | — | — | — | — | — | — |
| | Compound | | | | | | | | | | |
| | Hydrophilic | Layered | Lucentite SWN | 10 | 10 | — | — | — | — | — | |
| | Inorganic | | Kunipia F | — | — | 20 | — | — | — | — | |
| | Compound | | Lucentite SPN | — | — | — | — | — | — | — | |
| | | Bulk | BN-20 | — | — | — | 20 | 60 | — | — | — |
| | | | TTO-55D | — | — | — | — | — | 20 | — | — |
| | | | SN-100S* | — | — | — | — | — | — | 15 | 50 |
| | | | SN-100D* | — | — | — | — | — | — | — | — |
| | | | TTO-W-5* | — | — | — | — | — | — | — | — |
| | | | NANOBYK- | — | — | — | — | — | — | — | — |
| | | | 3600* | | | | | | | | |
| | | | β-Sic | — | — | — | — | — | — | — | — |
| | | | HHM-A-1/10 μm | — | — | — | — | — | — | — | — |
| | | Needle | Aluminasol | — | — | — | — | — | — | — | — |
| | | | 100* | | | | | | | | |
| | Surface | Coupling | KBM-503 | — | — | — | — | — | — | 4.5 | 9.1 |
| | Treatment | Agent | | | | | | | | | |
| | Agent | Hydro- | Swelling Agent | — | — | — | — | — | — | — | — |
| | | phobizing | | | | | | | | | |
| | | Treatment | | | | | | | | | |
| | | Agent | | | | | | | | | |
| | Surfactant | Emulsifying | LA-16* | 1 | 1 | — | — | — | — | 0.05 | 0.05 |
| | | Agent | | | | | | | | | |
| | | Dispersing | Shallol AN- | — | — | 1 | 1 | 1 | 1 | — | — |
| | | Agent | 103P* | | | | | | | | |
| | | | SN Dispersant | — | — | — | — | — | 5 | — | — |
| | | | 5045* | | | | | | | | |
| | | | Hexametha- | — | — | — | — | — | — | — | — |
| | | | phosphate Na | | | | | | | | |
| | | | EFKA 4550* | — | — | — | — | — | — | — | — |
| | Additive | Viscosity | SN Thickner | — | — | — | — | — | — | — | — |
| | | Adjuster | 634 | | | | | | | | |

| | | | | | | | | |
|---|---|---|---|---|---|---|---|---|
| Water (In Aqueous Dispersion) | 658 | 658 | 504 | 715 | 942 | 517 | 368 | 486 |
| Solid Content Concentration Upon | 15 | 15 | 20 | 20 | 20 | 20 | 20 | 18 |
| Polymerization [%] | | | | | | | | |

*solid content amount

TABLE 3

| | | | | Ex. | Ex. | Ex. | Ex. | Ex. | Ex. | Ex. | Ex. |
|---|---|---|---|---|---|---|---|---|---|---|---|
| | | | | 17 | 18 | 19 | 20 | 21 | 22 | 23 | 24 |
| Blending | Monomer Component | | BA | — | 100 | 100 | 100 | — | — | — | 100 |
| Formulation | | | St | — | — | — | — | — | — | — | — |
| | | | ISTA | — | — | — | — | — | — | 100 | — |
| | | | MMA | 100 | — | — | — | — | — | — | — |
| | | | 2EHA | — | — | — | — | 100 | — | — | — |
| | | | LMA | — | — | — | — | — | 100 | — | — |
| | | | KBM-503 | — | — | — | — | — | — | — | — |
| | Hydrophobic Compound | | Hexadecane | 3 | 3 | 3 | 3 | 3 | 3 | 3 | 3 |
| | Initiator | | V-601 | — | — | — | — | — | — | — | — |
| | | | AIBN | 0.2 | 0.2 | 0.2 | 0.2 | 0.2 | 0.2 | 0.2 | 0.2 |
| | Hydrophobic Inorganic | | Aerosil R8200 | — | — | — | — | — | — | — | — |
| | Compound | | | | | | | | | | |
| | Hydrophilic | Layered | Lucentite SWN | — | — | — | — | — | — | — | — |
| | Inorganic | | Kunipia F | — | — | — | — | — | — | — | — |
| | Compound | | Lucentite SPN | — | — | — | — | — | — | — | — |
| | | Bulk | BN-20 | — | — | — | — | — | — | — | — |
| | | | TTO-55D | — | — | — | — | — | — | — | — |
| | | | SN-100S* | 70 | 15 | 15 | — | — | — | — | — |
| | | | SN-100D* | — | — | — | 50 | 50 | 50 | 50 | 200 |
| | | | TTO-W-5* | — | — | — | — | — | — | — | — |
| | | | NANOBYK- | — | — | — | — | — | — | — | — |
| | | | 3600* | | | | | | | | |
| | | | β-Sic | — | — | — | — | — | — | — | — |
| | | | HHM-A-1/10 μm | — | — | — | — | — | — | — | — |
| | | Needle | Aluminasol | — | — | — | — | — | — | — | — |
| | | | 100* | | | | | | | | |
| | Surface | Coupling Agent | KBM-503 | 4.5 | 4.5 | 4.5 | 3.8 | 3.8 | 3.8 | 3.8 | 15.2 |
| | Treatment | Hydrophobizing | Swelling Agent | — | — | — | — | — | — | — | — |
| | Agent | Treatment | | | | | | | | | |
| | | Agent | | | | | | | | | |
| | Surfactant | Emulsifying Agent | LA-16* | 0.05 | 0.05 | 0.05 | 0.05 | 0.05 | 0.05 | 0.05 | 0.2 |
| | | Dispersing | Shallol AN- | 1 | 1 | — | — | — | — | — | — |
| | | Agent | 103P* | | | | | | | | |
| | | | SN Dispersant | — | — | — | 3 | 3 | 3 | 3 | 3 |
| | | | 5045* | | | | | | | | |
| | | | Hexamethaphosphate | — | — | — | — | — | — | — | — |
| | | | Na | | | | | | | | |
| | | | EFKA 4550* | — | — | — | — | — | — | — | — |
| | Additive | Viscosity | SN Thickner | — | — | — | — | — | — | — | — |
| | | Adjuster | 634 | | | | | | | | |

| | | | | | | | | |
|---|---|---|---|---|---|---|---|---|
| Water (In Aqueous Dispersion) | 486 | 368 | 268 | 167 | 167 | 167 | 167 | 111 |
| Solid Content Concentration Upon | 18 | 20 | 20 | 35 | 35 | 35 | 35 | 35 |
| Polymerization [%] | | | | | | | | |

*solid content amount

TABLE 4

| | | | | Ex. | Ex. | Ex. | Ex. | Ex. | Ex. | Ex. | Ex. |
|---|---|---|---|---|---|---|---|---|---|---|---|
| | | | | 25 | 26 | 27 | 28 | 29 | 30 | 31 | 32 |
| Blending | Monomer Component | | BA | 100 | 100 | 100 | 100 | 100 | 100 | 100 | 100 |
| Formulation | | | St | — | — | — | — | — | — | — | — |
| | | | ISTA | — | — | — | — | — | — | — | — |
| | | | MMA | — | — | — | — | — | — | — | — |
| | | | 2EHA | — | — | — | — | — | — | — | — |
| | | | LMA | — | — | — | — | — | — | — | — |
| | | | KBM-503 | — | — | — | — | — | — | 0.05 | — |
| | Hydrophobic Compound | | Hexadecane | 3 | 3 | 3 | 3 | 3 | 3 | 5 | 3 |
| | Initiator | | V-601 | — | — | — | — | — | — | 0.25 | — |
| | | | AIBN | 0.2 | 0.2 | 0.2 | 0.2 | 0.2 | 0.2 | — | 0.2 |
| | Hydrophobic Inorganic | | Aerosil R8200 | — | — | — | — | — | — | 5 | 5.0 |
| | Compound | | | | | | | | | | |
| | Hydrophilic | Layered | Lucentite SWN | — | — | — | — | — | — | 10 | — |
| | Inorganic | | Kunipia F | — | — | — | — | — | — | — | — |
| | Compound | | Lucentite SPN | — | — | — | — | — | — | — | — |
| | | Bulk | BN-20 | — | — | — | — | — | — | — | — |
| | | | TTO-55D | — | — | — | — | — | — | — | — |
| | | | SN-100S* | — | — | — | — | — | — | — | — |
| | | | SN-100D* | — | — | — | — | — | — | — | 50 |
| | | | TTO-W-5* | 50 | — | — | — | — | — | — | — |
| | | | NANOBYK- | — | 50 | — | 50 | — | — | — | — |
| | | | 3600* | | | | | | | | |
| | | | β-Sic | — | — | — | — | 50 | — | — | — |
| | | | HHM-A-1/10 μm | — | — | — | — | — | 50 | — | — |
| | | Needle | Aluminasol | — | — | 50 | 50 | — | — | — | — |
| | | | 100* | | | | | | | | |
| | Surface | Coupling Agent | KBM-503 | 3.8 | 3.8 | 15.3 | 16.2 | 1.9 | 0.5 | — | 3.8 |
| | Treatment | Hydrophobizing | Swelling Agent | — | — | — | — | — | — | — | — |
| | Agent | Treatment | | | | | | | | | |
| | | Agent | | | | | | | | | |
| | Surfactant | Emulsifying Agent | LA-16* | 0.05 | 0.05 | 0.05 | 0.05 | 0.05 | 0.05 | — | 0.05 |
| | | Dispersing | Shallol AN- | — | — | — | — | — | — | 0.5 | 3 |
| | | Agent | 103P* | | | | | | | | |
| | | | SN Dispersant | 3 | 3 | 3 | 3 | 3 | 3 | — | — |
| | | | 5045* | | | | | | | | |
| | | | Hexamethaphosphate | — | — | — | — | — | — | — | — |
| | | | Na | | | | | | | | |
| | | | EFKA 4550* | — | — | — | — | — | — | — | — |
| | Additive | Viscosity | SN Thickner | — | — | — | — | — | — | — | — |
| | | Adjuster | 634 | | | | | | | | |

| | | | | | | | | |
|---|---|---|---|---|---|---|---|---|
| Water (In Aqueous Dispersion) | 172 | 235 | 67 | 70 | 262 | 279 | 279 | 168 |
| Solid Content Concentration Upon | 35 | 35 | 35 | 35 | 35 | 35 | 30 | 35 |
| Polymerization [%] | | | | | | | | |

*solid content amount

TABLE 5

| | | | | Ref. | Ref. | Ref. | Ref. | Ref. |
|---|---|---|---|---|---|---|---|---|
| | | | | Comp. | Comp. | Comp. | Comp. | Comp. |
| | | | | Ex. 1 | Ex. 2 | Ex. 3 | Ex. 4 | Ex. 5 |
| Blending Formulation | Monomer Component | | BA | 100 | 100 | 100 | 100 | — |
| | | | St | — | — | — | — | — |
| | | | ISTA | — | — | — | — | 100 |
| | | | MMA | — | — | — | — | — |
| | | | 2EHA | — | — | — | — | — |
| | | | LMA | — | — | — | — | — |
| | | | KBM-503 | — | 0.03 | 0.03 | 0.03 | — |
| | Hydrophobic Compound | | Hexadecane | 5 | 5 | 5 | 5 | 5 |
| | Initiator | | V-601 | 0.25 | 0.25 | 0.25 | 0.25 | 0.25 |
| | | | AIBN | — | — | — | — | — |
| | Hydrophobic Inorganic | | Aerosil R8200 | — | — | — | — | — |
| | Compound | | | | | | | |
| | Hydrophilic | Layered | Lucentite SWN | 10 | 10 | 250 | 3 | — |
| | Inorganic | | Kunipia F | — | — | — | — | — |
| | Compound | | Lucentite SPN | — | — | — | — | — |
| | | Bulk | BN-20 | — | — | — | — | 20 |
| | | | TTO-55D | — | — | — | — | — |
| | | | SN-100S* | — | — | — | — | — |
| | | | SN-100D* | — | — | — | — | — |
| | | | TTO-W-5* | — | — | — | — | — |
| | | | NANOBYK- | — | — | — | — | — |
| | | | 3600* | | | | | |
| | | | β-Sic | — | — | — | — | — |
| | | | HHM-A-1/10 μm | — | — | — | — | — |
| | | Needle | Aluminasol | — | — | — | — | — |
| | | | 100* | | | | | |
| | Surface | Coupling Agent | KBM-503 | — | — | — | — | — |
| | Treatment | Hydrophobizing | Swelling Agent | — | — | — | — | — |
| | Agent | Treatment | | | | | | |
| | | Agent | | | | | | |
| | Surfactant | Emulsifying | LA-16* | — | 1 | 0.1 | 0.1 | — |
| | | Agent | | | | | | |
| | | Dispersing | Shallol AN- | — | — | — | — | — |
| | | Agent | 103P* | | | | | |
| | | | SN Dispersant | — | — | — | — | — |
| | | | 5045* | | | | | |
| | | | Hexamethaphosphate | — | — | 0.3 | 0.3 | — |
| | | | Na | | | | | |
| | | | EFKA 4550* | — | — | — | — | — |
| | Additive | Viscosity | SN Thickner | — | — | — | — | — |
| | | Adjuster | 634 | | | | | |

| | | | | | |
|---|---|---|---|---|---|
| Water (In Aqueous Dispersion) | 464 | 464 | 42.63 | 587 | 715 |
| Solid Content Concentration Upon | 20 | 20 | 8 | 15 | 20 |
| Polymerization [%] | | | | | |

*solid content amount

TABLE 6

| | | | | Comp. | Comp. | Comp. | Comp. | Comp. |
|---|---|---|---|---|---|---|---|---|
| | | | | Ex. 1 | Ex. 2 | Ex. 3 | Ex. 4 | Ex. 5 |
| Blending Formulation | Monomer Component | | BA | — | 100 | 100 | 100 | 100 |
| | | | St | — | — | — | — | — |
| | | | ISTA | 100 | — | — | — | — |
| | | | MMA | — | — | — | — | — |
| | | | 2EHA | — | — | — | — | — |
| | | | LMA | — | — | — | — | — |
| | | | KBM-503 | 0.03 | 0.03 | 0.03 | 0.03 | 0.03 |
| | Hydrophobic Compound | | Hexadecane | 5 | 5 | 5 | 5 | 5 |
| | Initiator | | V-601 | 0.25 | 0.25 | 0.25 | 0.25 | 0.25 |
| | | | AIBN | — | — | — | — | — |
| | Hydrophobic Inorganic | | Aerosil R8200 | — | — | — | — | — |
| | Compound | | | | | | | |
| | Hydrophilic | Layered | Lucentite SWN | — | 10* | 20* | — | |
| | Inorganic | | Kunipia F | — | — | — | — | — |
| | Compound | | Lucentite SPN | — | — | — | 10* | 10* |
| | | Bulk | BN-20 | — | — | — | — | — |
| | | | TTO-55D | — | — | — | — | — |
| | | | SN-100S* | — | — | — | — | — |
| | | | SN-100D* | — | — | — | — | — |
| | | | TTO-W-5* | — | — | — | — | — |
| | | | NANOBYK- | — | — | — | — | — |
| | | | 3600* | | | | | |
| | | | β-Sic | — | — | — | — | — |
| | | | HHM-A-1/10 μm | — | — | — | — | — |
| | | Needle | Aluminasol | — | — | — | — | — |
| | | | 100* | | | | | |
| | Surface | Coupling Agent | KBM-503 | — | — | — | — | — |
| | Treatment | Hydrophobizing | Swelling Agent | — | — | — | — | — |
| | Agent | Treatment | | | | | | |
| | | Agent | | | | | | |
| | Surfactant | Emulsifying | LA-16* | 3 | — | — | — | — |
| | | Agent | | | | | | |
| | | Dispersing | Shallol AN- | — | — | — | — | — |
| | | Agent | 103P* | | | | | |
| | | | SN Dispersant | — | — | — | — | — |
| | | | 5045* | | | | | |
| | | | Hexamethaphosphate | — | — | — | — | 20 |
| | | | Na | | | | | |
| | | | EFKA 4550* | — | — | — | — | — |
| | Additive | Viscosity | SN Thickner | — | — | — | — | — |
| | | Adjuster | 634 | | | | | |

| | | | | | |
|---|---|---|---|---|---|
| Water (In Aqueous Dispersion) | 106 | 90 | 80 | 90 | 90 |
| Solid Content Concentration Upon | 50 | 50 | 50 | 50 | 50 |
| Polymerization [%] | | | | | |

*solid content amount

### Comparative Examples 2 to 5

### Aqueous Dispersion was Blended in Aqueously-Dispersed Resin

TABLE 7

| | | | | Comp. | Comp. | Comp. | Comp. | Comp. | Comp. |
|---|---|---|---|---|---|---|---|---|---|
| | | | | Ex. 6 | Ex. 7 | Ex. 8 | Ex. 9 | Ex. 10 | Ex. 11 |
| Blending | Monomer Component | | BA | 100 | 100 | 100 | 100 | 100 | 101 |
| Formulation | | | St | — | — | — | — | — | — |
| | | | ISTA | — | — | — | — | — | — |
| | | | MMA | — | — | — | — | — | — |
| | | | 2EHA | — | — | — | — | — | — |
| | | | LMA | — | — | — | — | — | — |
| | | | KBM-503 | — | — | 0.05 | 0.05 | 0.05 | 0.05 |
| | Hydrophobic Compound | | Hexadecane | 3 | — | 5 | 5 | 5 | 5 |
| | Initiator | | V-601 | — | — | 0.25 | 0.25 | 0.25 | 0.25 |
| | | | AIBN | 0.2 | 0.5 | — | — | — | — |
| | Hydrophobic Inorganic | | Aerosil R8200 | — | — | — | 5 | 5* | — |
| | Compound | | | | | | | | |
| | Hydrophilic | Layered | Lucentite SWN | — | 10 | — | — | — | 5* |
| | Inorganic | | Kunipia F | — | — | — | — | — | — |
| | Compound | | Lucentite SPN | — | — | — | — | — | — |
| | | Bulk | BN-20 | — | — | — | — | — | — |
| | | | TTO-55D | — | — | — | — | — | — |
| | | | SN-100S* | 15* | — | — | — | — | — |
| | | | SN-100D* | — | — | — | — | — | — |
| | | | TTO-W-5* | — | — | — | — | — | — |
| | | | NANOBYK- | — | — | — | — | — | — |
| | | | 3600* | | | | | | |
| | | | β-Sic | — | — | — | — | — | — |
| | | | HHM-A-1/10 μm | — | — | — | — | — | — |
| | | Needle | Aluminasol 100* | — | — | — | — | — | — |
| | Surface | Coupling Agent | KBM-503 | 4.5 | — | — | — | — | — |
| | Treatment | Hydrophobizing | Swelling Agent | — | 14 | — | — | — | — |
| | Agent | Treatment | | | | | | | |
| | | Agent | | | | | | | |
| | Surfactant | Emulsifying | LA-16* | 0.2 | — | 0.5 | 0.5 | 0.5/0.5 | 0.5/0.5 |
| | | Agent | | | | | | | |
| | | Dispersing | Shallol AN-103P* | — | — | 0.5 | 0.5 | 0.5 | 0.5 |
| | | Agent | SN Dispersant | — | — | — | — | — | — |
| | | | 5045* | | | | | | |
| | | | Hexamethaphosphate | — | 14 | — | — | — | — |
| | | | Na | | | | | | |
| | | | EFKA 4550* | — | — | — | — | 10 | — |
| | Additive | Viscosity | SN Thickner 634 | — | — | 0.3 | — | 0.3 | 0.3 |
| | | Adjuster | | | | | | | |

| | | | | | | |
|---|---|---|---|---|---|---|
| Water (In Aqueous Dispersion) | 309 | 372 | 155 | 163 | 155 | 155 |
| Solid Content Concentration Upon | 23 | 20 | 40 | 40 | 40 | 40 |
| Polymerization [%] | | | | | | |

*solid content amount

### Comparative Examples 6, 10, and 11

### Aqueous Dispersion was Blended in Aqueously-Dispersed Resin

### Evaluation

### 1) Median Diameter of Oil Drops

For the monomer emulsions obtained in Examples 1 to 32, Referential Comparative Examples 1 to 5, and Comparative Examples 1 to 9, the volume-based average median diameter of oil drops was measured using a laser diffraction scattering particle size analyzer (LS13 320, laser light source: laser diode and tungsten lamp, wavelength 450 to 900 nm, manufactured by Beckman Coulter, Inc.). The results are shown in Table 8.

TABLE 8
Evaluation
Particle size

| | | | | | | | | | | | |
|---|---|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 | Ex. | Ex. |
| | | | | | | | | | | 10 | 11 |
| Median | 0.14 | 0.11 | 0.11 | 0.19 | 0.11 | 0.09 | 0.09 | 0.13 | 0.75 | 0.65 | 2.9 |
| Diameter of | | | | | | | | | | | |
| Oil Drops [μm] | | | | | | | | | | | |
| | Ex. 12 | Ex. 13 | Ex. 14 | Ex. 15 | Ex. 16 | Ex. 17 | Ex. 18 | Ex. 19 | Ex. 20 | Ex. | Ex. |
| | | | | | | | | | | 21 | 22 |
| Median | 32.6 | 30.0 | 0.20 | 0.09 | 0.18 | 0.17 | 0.35 | 0.36 | 0.17 | 0.51 | 1.75 |
| Diameter of | | | | | | | | | | | |
| Oil Drops [μm] | | | | | | | | | | | |
| | Ex. 23 | Ex. 24 | Ex. 25 | Ex. 26 | Ex. 27 | Ex. 28 | Ex. 29 | Ex. 30 | Ex. 31 | Ex. | |
| | | | | | | | | | | 32 | |
| Median | 1.76 | 0.28 | 0.19 | 0.14 | 1.27 | 0.24 | 1.34 | 0.10 | 0.14 | 0.21 | |
| Diameter of | | | | | | | | | | | |
| Oil Drops [μm] | | | | | | | | | | | |

| | | | | | |
|---|---|---|---|---|---|
| | Ref. Comp. Ex. 1 | Ref. Comp. Ex. 2 | Ref. Comp. Ex. 3 | Ref. Comp. Ex. 4 | Ref. Comp. |
| | | | | | Ex. 5 |
| Median | 0.12 | 66.10 | 0.09 | 0.42 | 33.60 |
| Diameter of | | | | | |
| Oil Drops [μm] | | | | | |

| | | | | | | | | | |
|---|---|---|---|---|---|---|---|---|---|
| | Comp. | Comp. | Comp. | Comp. | Comp. | Comp. | Comp. | Comp. | Comp. |
| | Ex. 1 | Ex. 2 | Ex. 3 | Ex. 4 | Ex. 5 | Ex. 6 | Ex. 7 | Ex. 8 | Ex. 9 |
| Median | 0.13 | 0.1 | 0.13 | 0.13 | 0.13 | 0.17 | 32.6 | 0.13 | 0.17 |
| Diameter of | | | | | | | | | |
| Oil Drops [μm] | | | | | | | | | |

### 2) Median Diameter of Inorganic-Polymer Composite Material

For the inorganic-polymer composite materials obtained in Examples 1 to 32, and Comparative Examples 1 to 9, the average median diameter was measured using a laser diffraction scattering particle size analyzer (LS 13 320, laser light source: laser diode and tungsten halogen lamp, wavelength 450 to 900 nm, manufactured by Beckman Coulter, Inc.). The results are shown in Table 9.

In Referential Comparative Examples 1 to 5, a large amount of coagulation generated.

TABLE 9
Evaluation
Particle Size

| | | | | | | | | | | | |
|---|---|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 | Ex. 10 | Ex. 11 |
| Median | 0.32 | 0.30 | 0.21 | 0.43 | 0.32 | 0.11 | 0.10 | 0.15 | 0.76 | 0.10 | 1.5 |
| Diameter of | | | | | | | | | | | |
| Inorganic- | | | | | | | | | | | |
| polymer | | | | | | | | | | | |
| Composite | | | | | | | | | | | |
| Material [μm] | | | | | | | | | | | |
| | Ex. 12 | Ex. 13 | Ex. 14 | Ex. 15 | Ex. 16 | Ex. 17 | Ex. 18 | Ex. 19 | Ex. 20 | Ex. 21 | Ex. 22 |
| Median | 31.2 | 19.8 | 0.22 | 0.31 | 0.86 | 1.06 | 2.35 | 1.02 | 3.10 | 1.73 | 1.71 |
| Diameter of | | | | | | | | | | | |
| Inorganic- | | | | | | | | | | | |
| polymer | | | | | | | | | | | |
| Composite | | | | | | | | | | | |
| Material [μm] | | | | | | | | | | | |
| | Ex. 23 | Ex. 24 | Ex. 25 | Ex. 26 | Ex. 27 | Ex. 28 | Ex. 29 | Ex. 30 | Ex. 31 | Ex. 32 | |
| Median | 1.79 | 0.21 | 1.77 | 3.00 | 2.99 | 2.56 | 2.08 | 0.55 | 1.62 | 0.46 | |
| Diameter of | | | | | | | | | | | |
| Inorganic- | | | | | | | | | | | |
| polymer | | | | | | | | | | | |
| Composite | | | | | | | | | | | |
| Material [μm] | | | | | | | | | | | |
| | Comp. | Comp. | Comp. | Comp. | Comp. | Comp. | Comp. | Comp. | Comp. | | |
| | Ex. 1 | Ex. 2 | Ex. 3 | Ex. 4 | Ex. 5 | Ex. 6 | Ex. 7 | Ex. 8 | Ex. 9 | | |
| Median | 0.22 | 0.22 | 0.22 | 0.22 | 0.22 | 0.40 | 42.1 | 0.34 | 0.46 | | |
| Diameter of | | | | | | | | | | | |
| Inorganic- | | | | | | | | | | | |
| polymer | | | | | | | | | | | |
| Composite | | | | | | | | | | | |
| Material [μm] | | | | | | | | | | | |

### 3) Polymerization Stability (Coagulation Rate)

The emulsions after production of the inorganic-polymer composite materials obtained in Examples 1 to 32, Referential Comparative Examples 1 to 5, and Comparative Examples 1 to 9 were filtered through a nylon mesh (#80); the total amount of the coagulation remained on the nylon mesh, and the coagulation adhered to the reaction vessel and stirring vane was weighed; and the coagulation rate was calculated based on the formula below. The results are shown in Table 10.

Coagulation Rate (%)={(A+B)/C}×100

A: weight of coagulation remained on nylon mesh

B: weight of coagulation adhered to reaction vessel and stirring vane

C: total weight of oil phase liquid component, hexadecane, hydrophilic clay mineral, hydrophilic inorganic compound, and hydrophobic inorganic compound

TABLE 10
Evaluation
Polymerization Stability

| | | | | | | | | | | | |
|---|---|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 | Ex. 10 | Ex. 11 |
| Coagulation | 0.3 | 0.7 | 0.4 | 0.1 | 0.1 | 0.1 | 0.1 | 0.4 | 0.0 | 0.1 | 0.1 |
| Rate [%] | | | | | | | | | | | |
| | Ex. 12 | Ex. 13 | Ex. 14 | Ex. 15 | Ex. 16 | Ex. 17 | Ex. 18 | Ex. 19 | Ex. 20 | Ex. 21 | Ex. 22 |
| Coagulation | 0.3 | 0.0 | 0.0 | 5.2 | 1.2 | 0.6 | 3.2 | 2.5 | 0.7 | 0.4 | 3.8 |
| Rate [%] | | | | | | | | | | | |
| | Ex. 23 | Ex. 24 | Ex. 25 | Ex. 26 | Ex. 27 | Ex. 28 | Ex. 29 | Ex. 30 | Ex. 31 | Ex. 32 | |
| Coagulation | 3.2 | 2.9 | 3.6 | 1.6 | 0.2 | 1.7 | 4.7 | 0.1 | 0.3 | 0.9 | |
| Rate [%] | | | | | | | | | | | |

| | | | | | |
|---|---|---|---|---|---|
| | Ref. Comp. Ex. 1 | Ref. Comp. Ex. 2 | Ref. Comp. Ex. 3 | Ref. Comp. Ex. 4 | Ref. Comp. Ex. 5 |
| Coagulation | 92.8 | 89.8 | 32.4 | 95.6 | 87.2 |
| Rate [%] | | | | | |

| | | | | | | | | | |
|---|---|---|---|---|---|---|---|---|---|
| | Comp. | Comp. | Comp. | Comp. | Comp. | Comp. | Comp. | Comp. | Comp. |
| | Ex. 1 | Ex. 2 | Ex. 3 | Ex. 4 | Ex. 5 | Ex. 6 | Ex. 7 | Ex. 8 | Ex. 9 |
| Coagulation | 0.3 | 0.3 | 0.3 | 0.3 | 0.3 | 0.2 | 65 | 0.1 | 0.3 |
| Rate [%] | | | | | | | | | |

### 4) Haze

An exfoliate film (polyethylene terephthalate substrate, Diafoil® MRF 38, manufactured by Mitsubishi Polyester Film Corp.) was coated with the emulsions of the inorganic-polymer composite material obtained in Examples 1 to 7, 31, Comparative Examples 1 to 5, and 8 to 11 so as to give thicknesses after drying of 25 μm and 100 μm; and afterwards, the coating was dried in a circulating hot air oven at 120° C. for 5 minutes, thereby forming a film composed of the inorganic-polymer composite material on the exfoliate film.

The film was cut into a size of 50 mm×50 mm; four of the coated film having such a size was laminated to give a thickness of 200 μm; and the haze was measured using a haze meter, HM-150 (manufactured by MURAKAMI COLOR RESEARCH LABORATORY CO., Ltd.). The results are shown in Table 11.

In Comparative Examples 2 to 5, the layered clay mineral easily coagulated, and when coated to form a film (sheet), a smooth and transparent film could not be obtained.

TABLE 11
Evaluation
Transparency
Haze

| | Ex. 1 | Ex. 2 | Ex. 3 | Ex. 4 | Ex. 5 | Ex. 6 | Ex. 7 | Ex. 31 | |
|---|---|---|---|---|---|---|---|---|---|
| 25 μm | 1.4 | 1.5 | 3.5 | 3.2 | 1.5 | 1.2 | 3.7 | 1.4 | |
| 100 μm | 3.3 | 3.2 | 3.7 | 4.5 | 3.3 | 3.5 | 8.5 | 3.2 | |
| | Comp. | Comp. | Comp. | Comp. | Comp. | Comp. | Comp. | Comp. | Comp. |
| | Ex. 1 | Ex. 2 | Ex. 3 | Ex. 4 | Ex. 5 | Ex. 8 | Ex. 9 | Ex. 10 | Ex. 11 |
| 25 μm | 0.6 | 11.5 | 4.0 | 2.3 | 1.0 | 0.5 | 1.1 | 3.2 | 2.8 |
| 100 μm | 0.8 | 20.3 | 15.5 | 10.2 | 1.2 | 0.8 | 2.5 | 5.8 | 5.2 |

### 5) Adhesiveness

Lumirror® S 10 #12 (polyester film, manufactured by TORAY INDUSTRIES, INC.) was coated with the emulsion of the inorganic-polymer composite material obtained in Examples 1 to 4, 31, Comparative Examples 1, 3, 4, and 8 to 11 so as to give a thickness after drying of 25 μm; and afterwards, the film was dried in a circulating hot air oven at 120° C. for 5 minutes, thereby forming a composite material film composed of the inorganic-polymer composite material on the polyethylene terephthalate substrate. This was used as evaluation samples.

These samples were cut to give a width of 25 mm, and bonded to a propylene plate and a glass plate (Corning #1737, manufactured by Corning Incorporated); and a 2 kg rubber roller was allowed to go back and forth (one round) to pressure bond the sample to the plate. The samples were allowed to stand in an autoclave of 50° C. and 0.5 MPa for 15 minutes, and then cooled to 25° C.; and the 90° peel adhesiveness (peeling speed 300 mm/min) was measured (initial adhesiveness).

Also, after the samples were allowed to stand in the autoclave, the samples were further allowed to stand for 24 hours under atmospheres at 60° C., and at 60° C./90% RH, and then cooled to 25° C.; and the 90° peel adhesiveness (peeling speed 300 mm/min) was measured. The results are shown in Table 12.

The higher the value of the peel adhesiveness is, the more excellent the adhesiveness is.

TABLE 12
Evaluation
Adhesiveness

| | | Ex. 1 | Ex. 2 | Ex. 3 | Ex. 4 | Ex. 31 | | |
|---|---|---|---|---|---|---|---|---|
| Adhesiveness to | 25° C. | 3.0 | 5.1 | 4.9 | 4.3 | 5.8 | | |
| PP [N/20 mm] | 80° C. × 24 H | 6.1 | 5.7 | 6.5 | 5.3 | 6.2 | | |
| | 60° C./90% RH × 24 H | 5.7 | 5.9 | 6.0 | 5.2 | 6.0 | | |
| Adhesiveness to | 25° C. | 5.8 | 5.4 | 6.0 | 3.4 | 6.4 | | |
| Glass [N/20 mm] | 80° C. × 24 H | 7.5 | 6.4 | 6.7 | 4.1 | 7.2 | | |
| | 60° C./90% RH × 24 H | 6.8 | 7.5 | 5.7 | 6.4 | 6.8 | | |
| | | Comp. | Comp. | Comp. | Comp. | Comp. | Comp. | Comp. |
| | | Ex. 1 | Ex. 3 | Ex. 4 | Ex. 8 | Ex. 9 | Ex. 10 | Ex. 11 |
| Adhesiveness to | 25° C. | 1.8 | 4.0 | 2.2 | 3.2 | 5.6 | 0.1 | 2.8 |
| PP [N/20 mm] | 80° C. × 24 H | 1.8 | 3.7 | 1.2 | 6.3 | 6.3 | 1.1 | 3.6 |
| | 60° C./90% RH × 24 H | 1.6 | 3.2 | 1.7 | 5.8 | 6.1 | 0.9 | 3.3 |
| Adhesiveness to | 25° C. | 0.9 | 3.2 | 2.1 | 0.5 | 8.2 | 0.1 | 1.7 |
| Glass [N/20 mm] | 80° C. × 24 H | 1.6 | 4.7 | 5.4 | 1.2 | 8.4 | 0.5 | 3.2 |
| | 60° C./90% RH × 24 H | 0.9 | 4.5 | 3.5 | 0.6 | 7.8 | 0.3 | 2.8 |

### 6) Stress-Strain Measurement

MFR (polyester film, manufactured by Mitsubishi Polyester Film Corp.) was coated with the emulsions of the inorganic-polymer composite material obtained in Examples 1 to 5, 31, Comparative Examples 1 to 3, 4, and 8 to 11 so as to give a thickness after drying of 25 μm; afterwards, the coating was dried in a circulating hot air oven at 120° C. for 5 minutes, thereby forming a film (adhesive layer) on the polyethylene terephthalate substrate; and this was used as evaluation samples.

These samples were cut to give a size of 30 mm×40 mm, and while peeling off from the exfoliate film, the adhesive layer was rolled from the end thereof so as not to allow air to enter, thereby forming a test piece of a 30 mm length cylindrical polymer composite material.

The longitudinal both end portions of 10 mm of this test piece were clipped to a tensile tester TG-1KN (manufactured by Minebea Co., Ltd.). Then, a stress-strain test was performed at a tensile speed of 50 mm/min, to obtain an initial elastic modulus, a break strength, an elongation at break, and a maximum stress. The results are shown in Table 13.

TABLE 13
Evaluation
Stress-Strain
Measurement

| | Ex. 1 | Ex. 2 | Ex. 3 | Ex. 4 | Ex. 5 | Ex. 31 | |
|---|---|---|---|---|---|---|---|
| Initial Elastic Modulus [Mpa] | 0.50 | 0.58 | 0.51 | 0.64 | 0.95 | 0.93 | |
| Break Strength [Mpa] | 0.28 | 1.08 | 0.83 | 0.56 | 0.90 | 1.43 | |
| Elongation at Break [%] | 2700 | 2400 | 2500 | 300 | 1500 | 2200 | |
| Maximum Stress [Mpa] | 0.45 | 1.08 | 0.83 | 0.64 | 0.95 | 1.43 | |
| | Comp. | Comp. | Comp. | Comp. | Comp. | Comp. | Comp. |
| | Ex. 1 | Ex. 3 | Ex. 4 | Ex. 8 | Ex. 9 | Ex. 10 | Ex. 11 |
| Initial Elastic Modulus [Mpa] | 0.08 | 0.41 | 0.38 | 0.07 | 0.09 | 0.11 | 0.29 |
| Break Strength [Mpa] | 0.37 | 0.86 | 1.12 | 0.26 | 0.39 | 0.43 | 0.4 |
| Elongation at Break [%] | 2500 | 1100 | 400 | 2100 | 1830 | 2100 | 1400 |
| maximum stress [Mpa] | 0.37 | 0.86 | 1.12 | 0.26 | 0.37 | 0.43 | 0.40 |

### 7) Dynamic Viscoelasticity Measurement

MFR (polyester film, manufactured by Mitsubishi Polyester Film Corp.) was coated with the emulsions of the inorganic-polymer composite material obtained in Examples 1 to 5, and Comparative Examples 1, 3, and 4 so as to give a thickness after drying of 25 μm; afterwards, the coating was dried in a circulating hot air oven at 120° C. for 5 minutes, thereby forming a film (adhesive layer) on the polyethylene terephthalate substrate; and this was used as evaluation samples.

These samples were laminated so as to give a thickness of 2±0.2 mm, and used as measurement samples. The samples thus made were stamped to give a circular shape having a diameter of 7.9 mm and the circular sample was clipped with parallel plates having a diameter of 7.9 mm and a load of 100 g was applied thereto. Storage modulus (G′), loss modulus (G″), and loss tangent (tan δ) were measured using a viscoelasticity spectrometer ARES (manufactured by Rheometric Scientific) at a frequency of 1 Hz and temperatures of 20° C. and 80° C. The results are shown in Table 14.

TABLE 14

| | | | | | | | | | Comp. | Comp. | Comp. |
|---|---|---|---|---|---|---|---|---|---|---|---|
| | | | | Ex. 1 | Ex. 2 | Ex. 3 | Ex. 4 | Ex. 5 | Ex. 1 | Ex. 3 | Ex. 4 |
| Evaluation | Dynamic | G ′[MPa] | 25° C. | 0.2 | 5.9 | 1.3 | 3.9 | 5.2 | 1.3 | 9.4 | 0.5 |
| | Viscoelasticity | G ″[MPa] | | 0.9 | 1.6 | 0.6 | 1.8 | 1.3 | 0.2 | 1.6 | 0.1 |
| | | tan δ | | 0.54 | 0.28 | 0.47 | 0.46 | 0.25 | 0.12 | 0.17 | 0.29 |
| | | G ′[MPa] | 80° C. | 0.1 | 0.3 | 0.2 | 0.4 | 0.3 | 0.1 | 0.4 | 0.2 |
| | | G ″[MPa] | | 0.3 | 0.5 | 0.3 | 0.5 | 0.5 | 0.02 | 0.10 | 0.05 |
| | | tan δ | | 2.1 | 1.7 | 1.7 | 1.2 | 1.7 | 0.2 | 0.3 | 0.2 |

### 8) SEM Observation

The emulsions of the inorganic-polymer composite material obtained in Examples 13 to 18, and 20 to 30 were diluted with water, dripped on a sample stage, and dried at 30° C. for 30 minutes. Then, after performing Pt—Pd sputtering for 5 seconds, SEM observation was performed using FE-SEM (S-4800 manufactured by HITACHI, Ltd.) with an acceleration voltage of 0.1 to 1 kV.

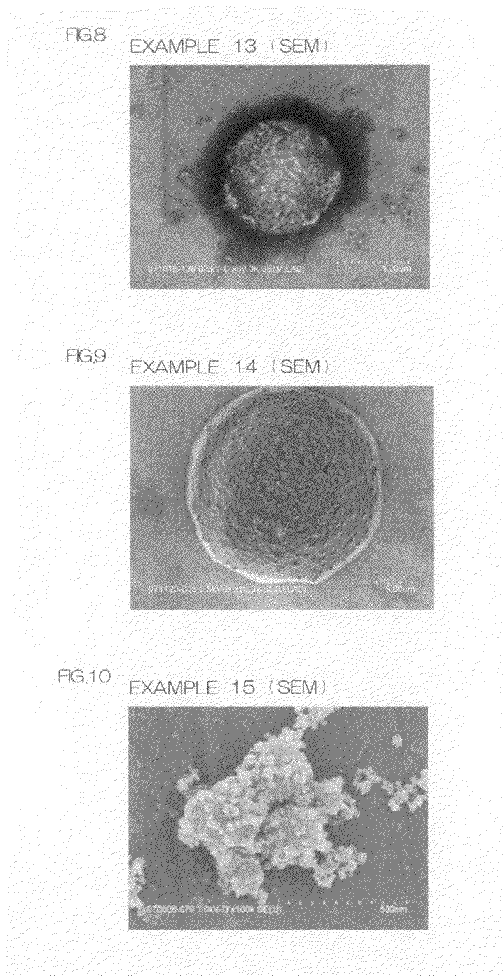

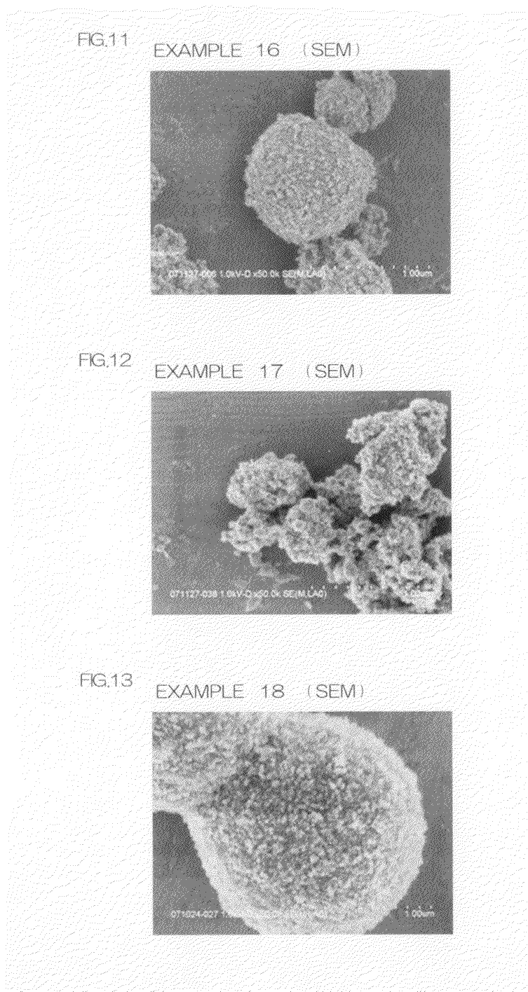

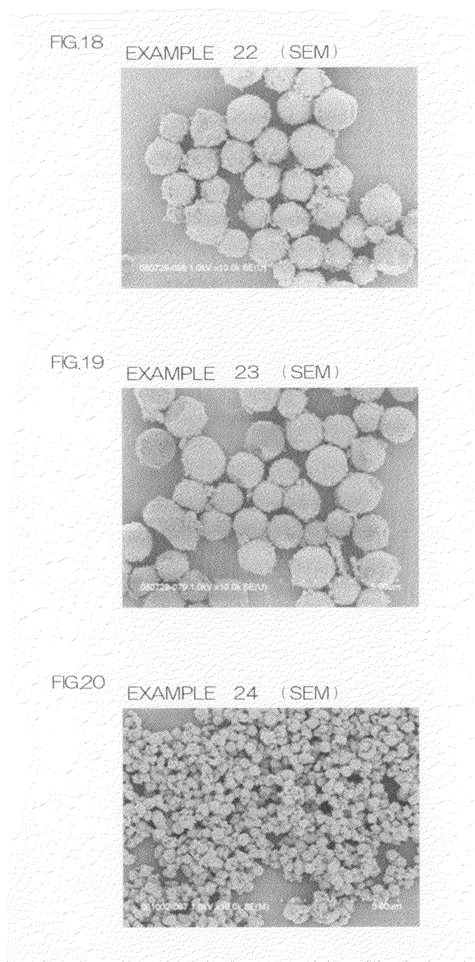

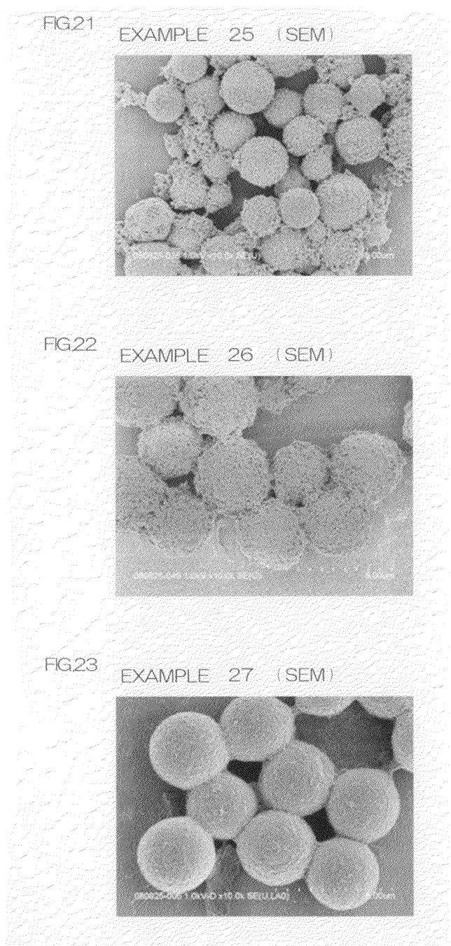

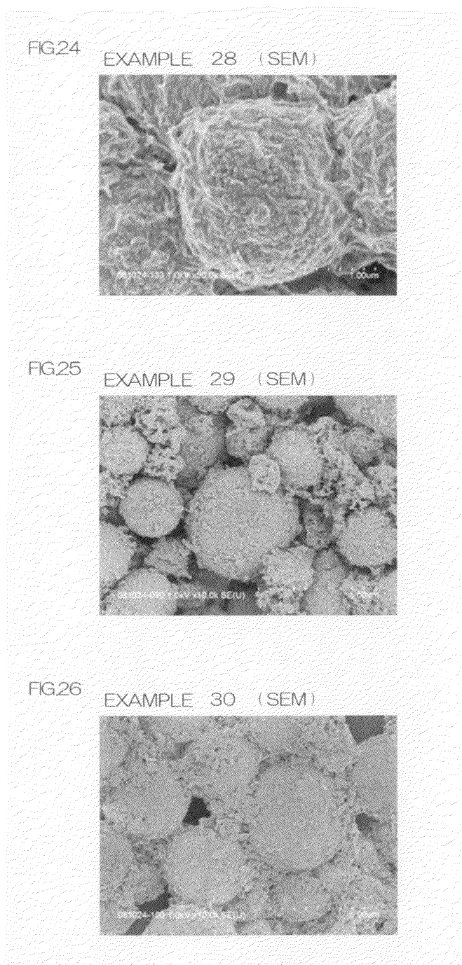

FIGS. 8 to 13, FIG. 15, and FIGS. 17 to 26 show processed SEM images.

### 9) TEM Observation

The emulsions of the inorganic-polymer composite material obtained in Examples 1, 2, 4, 8 to 10, 19, 20, 31, 32, and Comparative Example 7 were diluted with water, a drop of the resultant mixture was dripped on a sample stage with carbon film for TEM, dried, and observed using Hitachi H-7650, i.e., a transmission electron microscope manufactured by Hitachi Ltd. at an acceleration voltage of 100 kV.

Furthermore, the emulsions of the inorganic-polymer composite material obtained in Comparative Examples 3 to 6, and 8 to 11 were embedded in epoxy resin, stained by a treatment for 3 hours in a 2% aqueous solution of ruthenium acid. The samples were cut to give a thickness of about 80 nm with an ultramicrotome (Ultracut S, manufactured by Leica Microsystems), and then cross sections of these ultrathin sections were observed using Hitachi H-7650, i.e., a transmission electron microscope manufactured by Hitachi Ltd. at an acceleration voltage of 100 kV.

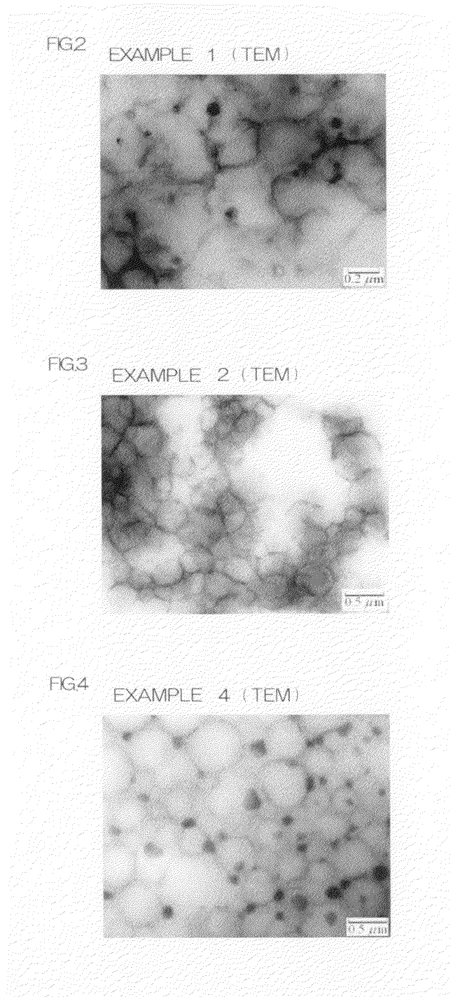

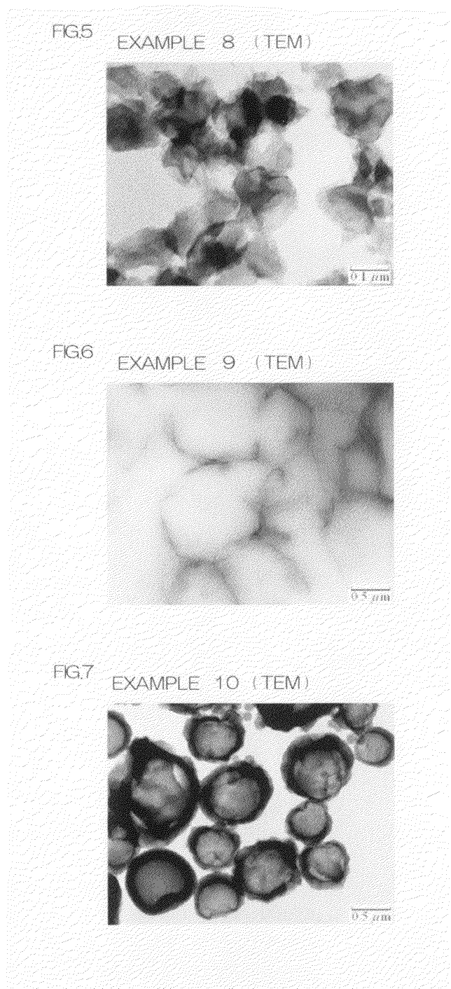

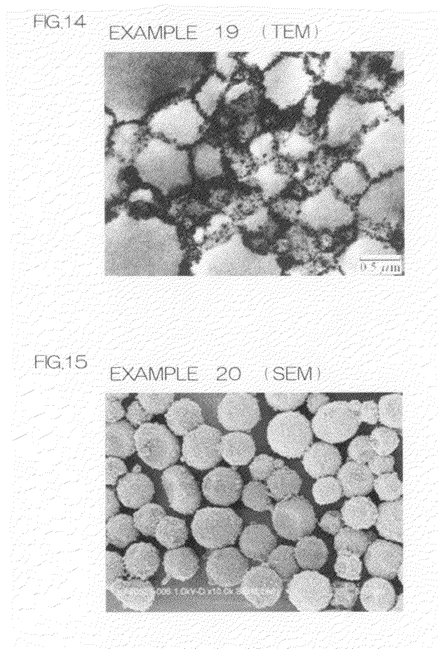

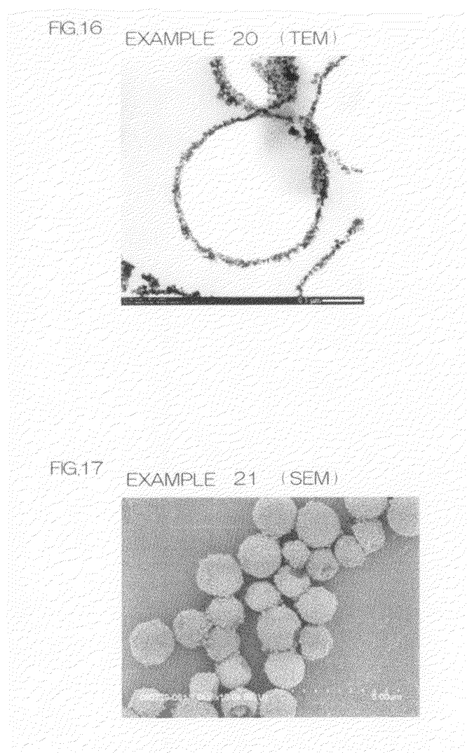

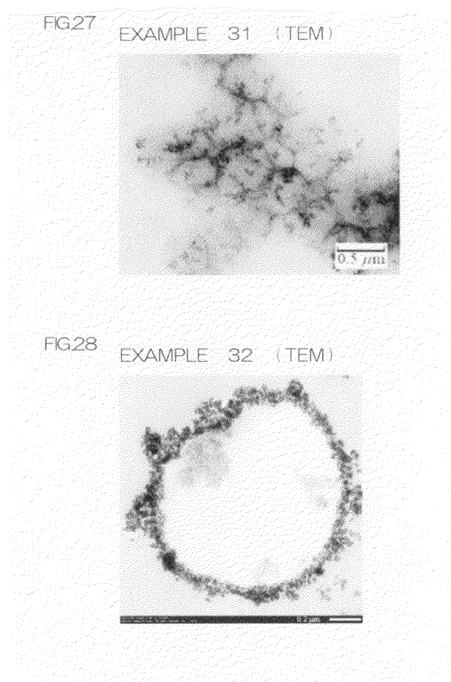

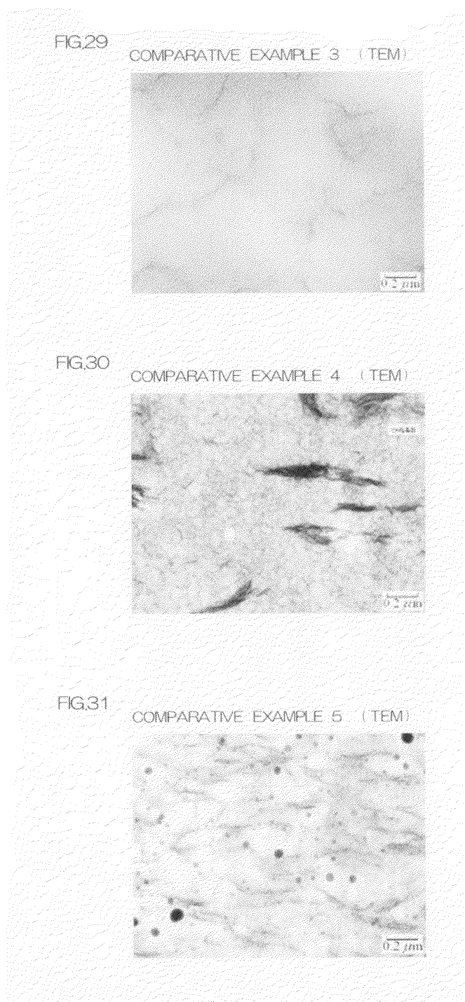

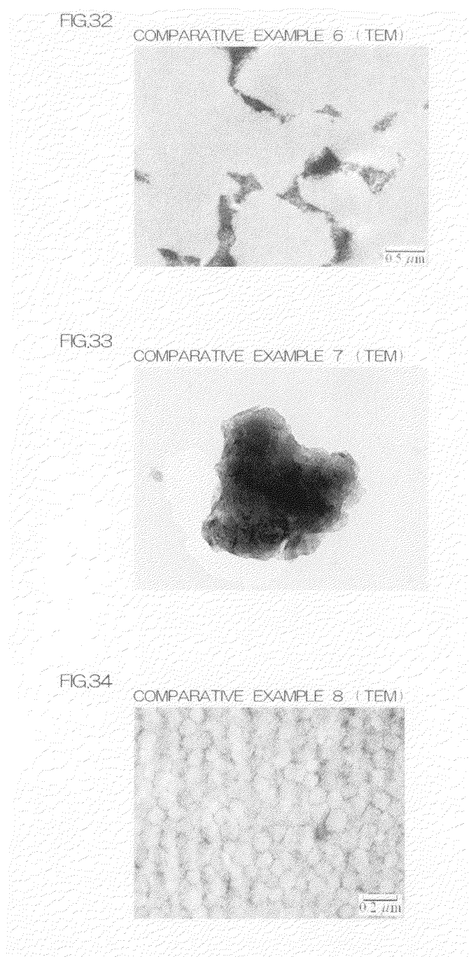

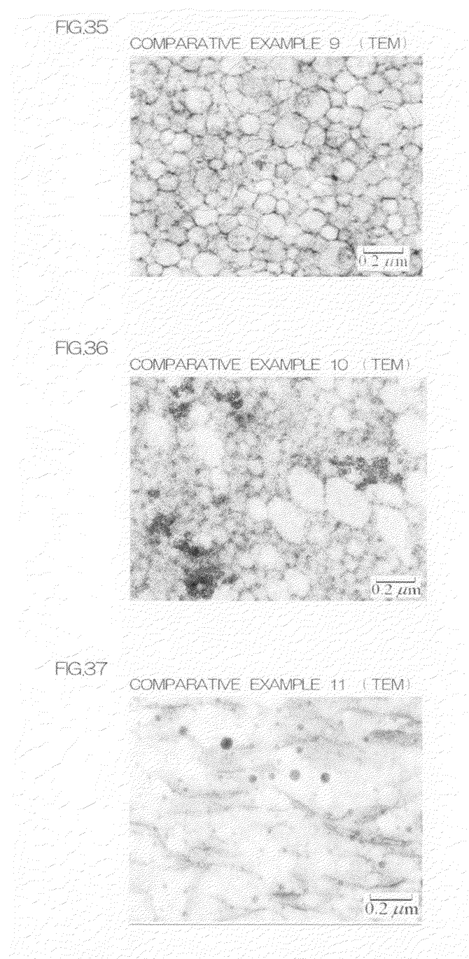

FIGS. 2 to 7, FIG. 14, FIG. 16, and FIGS. 27 to 37 show processed TEM images.

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICABILITY

The inorganic-polymer composite material of the present invention is suitably used in various industrial fields as a heat-releasing material or a conductive material, and also suitably used as an adhesive layer or an adhesive film.

1. An inorganic-polymer composite material comprising a hydrophilic inorganic compound that has a maximum length of 1 to 1000 nm and is unevenly distributed on the surface of a polymer particle having an average particle size of 0.05 to 100 μm.

2. The inorganic-polymer composite material according to claim 1, wherein the content proportion of the hydrophilic inorganic compound relative to 100 parts by weight of the polymer particle is 4 to 200 parts by weight.

3. The inorganic-polymer composite material according to claim 1, encapsulating a hydrophobic inorganic compound having a maximum length of 1 to 200 nm.

4. The inorganic-polymer composite material according to claim 3, wherein the content proportion of the hydrophobic inorganic compound relative to 100 parts by weight of the polymer particle is 0.1 to 15 parts by weight.

5. The inorganic-polymer composite material according to claim 3, wherein the hydrophobic inorganic compound is a hydrophobic inorganic compound having a bulk-form, needle-form, or plate-form.

6. The inorganic-polymer composite material according to claim 1, wherein the polymer particle is an aqueous-dispersion type polymer particle.

7. The inorganic-polymer composite material according to claim 1, wherein the hydrophilic inorganic compound is a hydrophilic layered clay mineral, and/or a hydrophilic inorganic compound having a bulk-form, needle-form, or plate-form.

8. An adhesive layer comprising an inorganic-polymer composite material, wherein the inorganic-polymer composite material comprises a hydrophilic inorganic compound that has a maximum length of 1 to 1000 nm and is unevenly distributed on the surface of a polymer particle having an average particle size of 0.05 to 100 μm.

9. An adhesive film comprising an adhesive layer on at least one side of a support, wherein the adhesive layer contains an inorganic-polymer composite material,
the inorganic-polymer composite material comprising a hydrophilic inorganic compound that has a maximum length of 1 to 1000 nm and is unevenly distributed on the surface of a polymer particle having an average particle size of 0.05 to 100 μm.
